(19) United States
(12) Patent Application Publication
(10) Pub. No.: US 2014/0007631 A1
(43) Pub. Date: Jan. 9, 2014

(54) LATCH OR LOCK

(71) Applicant: Assa Abloy Australia Pty Ltd, Oakleigh (AU)

(72) Inventors: David Wood, Morningside (AU); Colin Horton, Chapel Hill (AU)

(21) Appl. No.: 13/906,985

(22) Filed: May 31, 2013

(30) Foreign Application Priority Data
Jun. 1, 2012 (AU) 2012902300

(51) Int. Cl. E05B 63/08; E05C 1/00

(52) U.S. Cl. CPC E05B 63/08; E05C 1/004
USPC 70/357; 292/145

(57) ABSTRACT

A lock or latch having a latch bolt movable linearly between latching and unlatching positions; a rotatable operator; a drive member movable linearly between first second positions in a direction transverse to the latch bolt's direction of movement, wherein movement of the drive member from the first position to the second position can be caused by rotation of the operating means, and a contact part is associated with the latch bolt and can move linearly between non-retracting and retracting positions in a direction parallel to the latch bolt's direction of movement.

### RELATED APPLICATIONS

This application claims priority to Australian Patent Application No. 2012902300 filed on Jun. 1, 2012 and is hereby being incorporated by reference in its entirety.

### TECHNICAL FIELD

The present invention relates to locks and latches for openable and closable wings such as, for example, doors and windows. In particular, the invention is concerned with locks and latches for wings which open and close in a swinging manner. Examples of such wings include hinged doors and hinged windows.

For convenience, the invention will be described primarily with reference to its application on hinged doors, for example, residential front doors and the like. However, it is to be clearly understood that this is for convenience only and it does not imply any limitation in relation to the invention; indeed the invention could also be used on other forms of openable and closable wings.

### BACKGROUND

Australian Patent No. 662657 in the name of Gainsborough Hardware Industries Limited describes a so-called dual function lock mechanism. Gainsborough Hardware Industries Limited has also produced a lock which is a modification/evolution of the lock in Patent No. 662657 and which is sold under the Australian trade mark TRILOCK®. However, there are a number of problems and difficulties with this lock.

One of the problems relates to difficulties and complications associated with installing the lock on the door. Often, during the initial stages of installation when the lock's latch bolt is inserted through the side edge of the door to connect with the key cylinder assembly (the key cylinder assembly is mounted transversely in the door), it is necessary to almost completely disassemble the latch bolt assembly in order to reorient the latch bolt. (The orientation of the latch bolt may need to be changed depending on whether the door is left-handed or right-handed, or opens inward or outward). In any case, after the latch bolt assembly has been disassembled to allow the latch bolt to be correctly oriented, the latch bolt assembly must then be reassembled for insertion and connection to the key cylinder assembly. This can significantly increase the time taken to install the lock, even for locksmiths experienced in performing this task.

Another problem arises where the lock handles are of a lever type. Specifically, the problem relates to the means by which the handedness of the lock is changed. As part of changing the handedness of the lock, prior to installing each lock handle assembly on the door, it is necessary to use a flat bladed screwdriver to pry up a retaining “handing” plate which is on the inside of the handle assembly. After the handing plate has been prised away from its mounting, the lever handle can be rotated 180° relative to the rest of the handle assembly, thereby swapping the handedness of the lock. After the handle has been rotated 180°, the handing plate clicks back into place. In practice, using a flat bladed screwdriver to lift the handing plate can be difficult, and also dangerous. This is partly because of the amount of force required to force the blade of the screwdriver beneath the handing plate and to lift the plate relative to its mounting. However, additional difficulties also arise because of the way it is necessary to grasp the handle assembly in one hand and, with the other hand, use a screwdriver to prise the handing plate away from its mounting. Due to the particular configuration of the components, and the consequent way in which the handle assembly must be held, there is often a significant risk that any slip of the screwdriver during this process could cause the screwdriver to slide (with considerable force) into the user's other hand/arm, with the potential to cause considerable injury.

It may be desirable to ameliorate one or more of the above problems, or to at least provide an alternative lock or latch for use in the marketplace. For example, and without implying any limitation, it may be desirable to provide a lock which could be used as an alternative to the above lock produced by Gainsborough Hardware Industries Limited.

It is to be clearly understood that mere reference herein to previous or existing products, practices, publications or other information, or to any associated problems or issues, does not constitute an acknowledgement or admission that any of those things individually or in any combination formed part of the common general knowledge of those skilled in the field or are admissible prior art.

### SUMMARY OF INVENTION

In one form, the present invention resides broadly in a lock or latch having:

a latch bolt which can move linearly between a latching position and an unlatching position;

rotatable operating means that can be operated by a user;

a drive member which can move linearly between a first position and a second position in a direction at least partially transverse to the latch bolt's direction of movement, wherein movement of the drive member from the first position to the second position can be caused by rotation of the operating means, the drive member also having a contact surface oriented at an angle to its direction of linear movement, and

a contact part which is associated with the latch bolt and which can move linearly between a non-retracting position and a retracting position in a direction at least partially parallel to the latch bolt's direction of movement,

wherein the angled contact surface of the drive member engages the contact part, or a portion of the contact part, such that when the drive member moves from the first position to the second position, the contact part, or the said portion of the contact part, moves along the contact surface due to the angle of engagement with the contact surface, thereby moving the contact part from the non-retracting position to the retracting position, and

wherein movement of the contact part from the non-retracting position to the retracting position causes the latch bolt to move from the latching position to the unlatching position.

The present invention may, in different embodiments, relate to a latch or a lock. As those skilled in the art will understand, a latch is a device for fastening a door or window (or some other such “wing”) which has no locking function. In contrast, a lock has a locking function. Therefore, with locks, it is possible, using the lock, to prevent the lock from being operated from one or both sides, or to allow the lock to be operated from one or both sides. This is not possible with a latch.

As mentioned above, the lock or latch has a latch bolt which can move linearly between a latching position and an unlatching position. The latch bolt is therefore a reciprocating latch bolt (as distinct from rotating “hook”-type bolt). The head portion of the latch bolt (i.e. the portion of the latch bolt which protrudes out from the edge of the door to engage with the doorjamb when the latch bolt is in the latching position) may have a generally conventional configuration, similar to other previous reciprocating latch bolts. That is, it may have a rounded or bevelled edge which, when the latch bolt is installed for or in use, faces towards the doorjamb or strike. The rounded/bevelled end of the latch bolt head functions such that, when the latch bolt head comes into contact with the doorjamb or strike as the door or window swings closed, the angle of the rounded/bevelled portion causes the latch bolt to be pushed back into the lock or latch to allow the door to swing fully closed. Once the door is fully closed, the latch bolt then protrudes back out (under the bias of a spring) to insert into a cavity in (or otherwise engage with) the doorjamb or strike to prevent the door from swinging open.

Whilst the head of the latch bolt may be generally conventional, in certain embodiments the latch bolt may be part of a latch bolt assembly configured specifically to operate with embodiment of the lock/latch. In fact, one form of the invention may be considered to reside in a latch bolt assembly for use with a lock or latch, the latch bolt assembly including a bolt, a bolt casing and an engaging portion, wherein the bolt can move relative to the casing between an extended position in which a portion of the bolt projects out from the front of the casing and a retracted position in which the said portion of the bolt is withdrawn at least partially relative to the casing, and the engaging portion is directly or indirectly connected to the bolt, the engaging portion extends out from the rear of the casing and is operable or configured to engage with a part of the lock or latch which can move in a similar manner to the bolt from an un-operated position to an operated position such that, when the latch bolt assembly is connected to the lock or latch in use, operation of the lock or latch can cause the said part of the lock or latch to move from the un-operated position to the operated position and this can in turn cause the bolt to move from the extended position to the retracted position.

The lock or latch incorporates rotatable operating means that can be operated by a user. There is no limitation on the kind of rotatable operating means that could be used. For instance, the rotatable operating means could comprise one or a combination of the following manually-operable means: one or more turnable doorknobs or lever handles, one or more key cylinders (into which a key can be inserted and turned), one or more turn knobs or twist knobs, etc. It is envisaged that such manually-operable means will be used most often. However, non-manual rotatable means such as, for example, electric motor-driven rotating means (which could be activated by the press of a button or by a remote control key fob, etc) could also be used. Indeed, any other rotatable operating means known to those skilled in the art could be used.

Without limiting anything in the previous paragraph, it is envisaged that latches in accordance with the present invention will typically include a lever handle for operating the latch to retract the latch bolt. If the latch is for use on a window, the latch may have only a single lever handle for operating the latch from the inside (on windows there is generally no need for an outside handle). On the other hand, if the latch is for use on a door, it may have an inside handle and an outside handle so that the latch can be operated (and the door can be opened) from the inside and the outside (although this should not be construed to mean that the latch must have two handles if it is used on a door; a latch used on a door could potentially also have only a single handle).

Again, without limiting anything in the previous two paragraphs, it is envisaged that locks in accordance with the invention will typically include, as the rotatable operating means, a lever handle, or a key cylinder, or both. If intended for use on a window, the lock may have a handle and/or key cylinder on the inside only. On the other hand, if the lock is for use on a door, it may have a handle and/or key cylinder on the inside and a handle and/or key cylinder on the outside. Typically, the inside and the outside will be the same, such that if the inside has a handle and a key cylinder, the outside will also have a handle and a key cylinder. Similarly, if the inside has only a key cylinder, the outside will also have only a key cylinder. However, no strict limitation is to be implied from this and the rotatable operating means on the inside need not necessarily be the same as on the outside.

Locks and latches in accordance with embodiments of the invention incorporate a drive member which can move linearly between a first position and a second position in a direction which is at least partially transverse to the latch bolt's direction of movement. Therefore, if the latch bolt extends horizontally out from the side edge of the door or window (as will often be the case) and therefore moves horizontally between the latching position and the unlatching position, the drive member will move between its first and second position is in a direction which is at least partially vertical (i.e. in a direction which has a vertical component). Typically, the direction of movement of the drive member will be perpendicular (or close to perpendicular) relative to the latch bolt's direction of movement.

In any case, movement of the drive member from the first position to the second position can be caused by rotation of the operating means. The way in which rotation of the operating means can cause the drive member to move from the first position to the second position is not narrowly critical. Therefore, any suitable means or mechanisms may be interposed between the rotatable operating means and the drive member to enable movement of the drive member from the first position to the second position to be caused by operation of the rotatable operating means. One or more non-limiting examples of such means or mechanisms will be given below.

The drive member may take any suitable form or configuration. For instance, in many embodiments, the drive member may be configured as a mostly flat, plate-like component. However, no limitation whatsoever is to be implied from this, and the drive member could alternatively take any other shape or configuration such as (by way of non-limiting example only) a block-like or rod-like component, or a component having a complex multi-part geometry.

The lock or latch incorporates a contact part, which is associated with the latch bolt, and which can move linearly between a non-retracting position and a retracting position in a direction which is at least partially parallel to the latch bolt's direction of movement (meaning that the direction of movement of the contact part is at least partially transverse to the drive member's direction of movement). As mentioned above, the latch bolt will typically move horizontally and the drive member will typically move (at least approximately) vertically. Where this is the case, the direction of movement of the contact part will generally be (at least approximately) horizontal.

As mentioned above, the contact part is associated with the latch bolt. In other words, movement of the contact part is linked to movement of the latch bolt. More specifically, movement of the contact part from the non-retracting position to the retracting position causes the latch bolt to move from the latching position to the unlatching position. Any suitable means or mechanisms for creating this relationship between the movement of the contact part and the movement of the latch bolt may be used. One or more non-limiting examples of such means or mechanisms will be given below.

The drive member has a contact surface which is oriented at an angle to the drive member's (typically vertical) direction of linear movement. The angled contact surface engages the contact part (or a portion of the contact part) such that when the drive member moves (vertically) from the first position to the second position, the contact part (or the said portion of the contact part) moves along the contact surface due to the angle of engagement, thereby moving the contact part (horizontally) from the non-retracting position to the retracting position.

The contact surface may be straight or curved. If it is straight, the angle that it makes relative to the drive member's direction of movement will be constant for the whole contact surface. If it is curved, the angle will change along the contact surface. Further explanations will be given with reference to embodiments where the contact surface is straight (as is likely to be the case most often), although no limitation is to be implied from this.

It is envisaged that the angle between the orientation of the straight contact surface and the drive member's direction of movement may, in many embodiments, be approximately 45°. However, the angle may also be varied to suit. If the angle is reduced (i.e. if the angle of the contact surface is closer to parallel with the drive member's direction of movement), the distance which the contact part moves when the drive member moves from the first position to the second position will be reduced, but the amount of force required to move the contact part will also be reduced. Conversely, if the angle is increased (i.e. if the angle of the contact surface is closer to perpendicular with the drive member's direction of movement), the distance which the contact part moves when the drive member moves from the first position to the second position will be increased, but the force required to move the contact part will also be increased.

There is no limitation, in terms of form or configuration, on the part or portion of the drive member which comprises/forms/functions as the contact surface. Therefore, any ridge, edge, side, face, surface or other part or portion of the drive member may form, or function as, the contact surface. In certain embodiments, the drive member may be provided with a slot, indent or cutout therein, and a side or edge of the slot, indent or cutout which is oriented at an angle to the direction of linear movement of the drive member may form the contact surface. (If the said side or edge of the slot, indent or cutout is straight, the contact surface will of course be straight.)

The lock or latch may further comprise a transfer component which has a lug or detent thereon, and the lug or detent may form the contact part which engages with the contact surface of the drive member. The transfer component may also include a further portion which, when the lock or latch is assembled for or in use, directly or indirectly engages the latch bolt such that movement of the transfer component (with the contact part) between the non-retracting position and the retracting position causes latch bolt to move from the latching position to the unlatching position. In saying that this portion of the transfer component “directly or indirectly” engages the latch bolt, this means that this portion of the transfer component either directly contacts a portion of the latch bolt, or otherwise it contacts or connects with one or more intervening components which in turn contact with, and operate, the latch bolt.

The transfer component may take any suitable form or configuration. For instance, it may include a flat, plate-like portion, and the lug or detent (the contact part) which engages the contact surface of the drive member may be formed on a face of the plate-like portion. Furthermore, the transfer component may include a projecting arm or rod like portion which extends perpendicular to the plane of the plate-like portion. This arm or rod-like portion could extend out from the same side of the plate-like portion as the lug or detent, or from the opposite side. The arm or rod-like portion may also engage with the latch bolt, or it may engage with one or more intervening components which in turn contact with, and operate, the latch bolt. However, it is to be clearly understood that the configuration of the transfer component just described (i.e. with the plate-like portion having the lug or detent thereon and the arm or rod-like portion extending therefrom) is only one non-limiting example. Myriad other forms and configurations of the transfer component are also possible.

As mentioned above, the drive member may be provided with a slot, indent or cutout therein, and a side or edge of the slot, indent or cutout which is oriented at an angle to the direction of linear movement of the drive member may form the contact surface. In some embodiments, the drive member may in addition have a second slot, indent or cutout therein, and a side or edge of the second slot, indent or cutout which is oriented at an angle to the direction of linear movement of the drive member may form a second contact surface. In such embodiments, the lock or latch may further comprise a second transfer component, and the contact part of the second transfer component may engage with the second contact surface.

Like the first-mentioned transfer component (described above), the second transfer component may move linearly between a non-retracting position and a retracting position. The direction of movement of the second transfer component may be parallel but opposite to the direction of movement of the first-mentioned transfer component. Movement of the second transfer component in the opposite direction relative to the first-mentioned transfer component may be caused by a different orientation of the second contact surface relative to that of the first-mentioned contact surface. The explanations given above regarding the possible configuration of the first-mentioned transfer component apply equally to the second transfer component. Therefore, the second transfer component may have a lug or detent thereon which forms the contact part that engages the second contact surface, and it may also have a portion (which may be configured as an arm or rod-like portion) which can, in use, directly or indirectly engage the latch bolt, etc.

In embodiments having two transfer components (which engage with respective contact surfaces etc), when the lock or latch is assembled for or in use, only one of the transfer components may interact with the latch bolt, but the two transfer components may be provided to enable the lock or latch to be configured in either handedness, as required. In other words, one of the transfer components (only) may interact with the latch bolt if the lock or latch is configured and installed in one handedness, and the other transfer component (only) may interact with the latch bolt if the lock or latch is configured and installed in the other handedness.

In the embodiments described above where the drive member has two contact surfaces, and there are two transfer components (one for each contact surface), etc, each contact surface may mirror the other (typically about an axis which is central to the drive member and parallel to the drive member's direction of movement). Therefore, if one contact surface is straight, the other may also be straight, or if one contact surface is curved, the other may also be curved. Furthermore, in the case where the respective contact surfaces are straight, they may be oriented at an equal but opposite angles, respectively, relative to the direction of movement of the drive member. For example, if one of the contact surfaces is oriented at 45° to the drive member's direction of movement, the other contact surface may be oriented at −45° (that is, it may slope 45° the other way) relative to the drive member's direction of movement.

As has previously been explained, the lock or latch in accordance with embodiments of the invention may be configured for mounting to a door, and if so, it may be provided with a lever handle for each of the inside and the outside of the door. Furthermore, the inside handle may be part of, or may attach to, and an inside handle assembly which is securable on the inside of the door, and the outside handle may be part of, or may attach to, an outside handle assembly which is securable on the outside of the door.

The inside handle assembly, or the outside handle assembly, or both (and typically both), may include a component which can be pressed or otherwise moved without disassembling the assembly in any way, and pressing or moving the said component may enable the handle of the assembly to be rotated relative to the assembly so as to swap the handedness of the assembly. Typically, the said component which can be pressed or moved may only be accessible before the assembly is secured on the relevant side of the door. Therefore, the handle assembly may be placed in the appropriate handedness for the door on which it is be installed, and it may then be installed on the door, and once installed it may not be possible to alter the handedness, at least not without removing the assembly from the door.

The lock or latch may further include a spindle assembly. The spindle assembly may include a spindle and, in use, the spindle assembly may extend between the inside handle assembly and the outside handle assembly. Rotation of the outside handle may cause rotation of the spindle, and to facilitate this the spindle may connect directly to the outside handle, or otherwise the outside handle may be connected indirectly to the spindle (e.g. via one or more intervening components), or otherwise the outside handle may be associated with the spindle in such a way that rotation of the outside handle causes rotation of the spindle.

The spindle may be linked to the inside handle by one or more intermediate components. These intermediate components may include a drive part and a spindle component. In use, rotation of the inside handle may cause rotation of the drive part. To facilitate this, the drive part may connect directly to the inside handle, or otherwise the inside handle may be indirectly connected to the drive part in such a way that rotation of the inside handle causes rotation of the drive part. The spindle component may rotate with the spindle. In many embodiments, the spindle component may be fixedly mounted on the spindle and may therefore rotate with the spindle (although no limitation is to be implied from this and other configurations are possible). Rotation of the spindle may cause the spindle component to engage with the drive part and thereby cause rotation of the drive part. Any means or mechanisms may be used to achieve this. And furthermore, rotation of the drive part may cause the drive member to move from the first position to the second position.

As explained above, rotation of the outside handle may cause rotation of the spindle, rotation of the spindle may cause the spindle component to engage with the drive part and thereby cause rotation of the drive part, and rotation of the drive part may cause the drive member to move from the first position to the second position. This may therefore be how rotation of the outside handle causes the drive member to move from the first position to the second position in these embodiments.

As also explained above, rotation of the inside handle may cause rotation of the drive part, and rotation of the drive part may cause the drive member to move from the first position to the second position. This may therefore be how rotation of the inside handle causes the drive member to move from the first position to the second position in these embodiments.

In embodiments which have a drive part (as discussed above), and where the drive part, in use, rotates with the inside handle, the drive part may have a portion which engages with the drive member. The said portion may comprise a protruding lug on the drive part (a drive lug), although a range of other parts or portions of the drive part (or even separate components connected to the drive part) could also be configured to engage with the drive member. In any case, when the drive part rotates (in what may be described as an opening direction) the drive lug (or other part or portion of the drive part) may engage with the drive member and thereby cause the drive member to move linearly from the first position to the second position. Suitably, the drive lug (or other part or portion of the drive part) may engage with an edge, ridge or surface on the drive member to cause the drive member to move from the first position to the second position.

In embodiments of the invention which relate to a lock for a door, and where the lock has an inside handle assembly (including the inside handle) on the inside and an outside handle assembly (including the outside handle) on the outside, the lock may include a snib mechanism which, when operated in use, prevents the outside handle from being operated to retract the latch bolt. The snib mechanism may include a button or turn knob mounted as part of the inside handle assembly (making the button or turn knob operable from the inside of the door). When the button or turn knob is operated, a snibbing component (which may be a part in the inside handle assembly) may move from an un-snibbing position in which it (the snibbing component) does not prevent rotation of the spindle into a snibbing position in which it does prevent rotation of the spindle. Recall from above that, in certain embodiments, rotation of the outside handle causes rotation of the spindle, which in turn (through interaction with other components) causes the drive member to move from the first position to the second position to retract the latch bolt. Therefore, if the snibbing component is moved into the snibbing position thereby preventing the spindle from rotating, this may therefore prevent operation of the outside handle to retract the latch bolt. This may be referred to as “snibbing” the lock (and the lock may thus be referred to, when it is in this condition, as “snibbed”).

In embodiments which incorporate a snib mechanism as described in the previous paragraph, the lock may also be provided with means for moving the snibbing component back from the snibbing position into the un-snibbing position (i.e. means may be provided for “un-snibbing” the lock so that the outside handle can again be used to retract the latch bolt). There is no limitation whatsoever as to the form or configuration that the un-snibbing means may take. For example, in embodiments where a turn knob is provided for operating the snib mechanism, turning the turn knob in one direction may snib the lock and turning the turn knob in the opposite direction may un-snib the lock. However, in other embodiments, the lock may be configured such that the snibbing component can be moved from the snibbing position to the un-snibbing position by rotation of the inside handle. One possible configuration for achieving this functionality is given below, by way of non-limiting example only, with reference to the drawings.

In embodiments of the invention which relate to a lock (and this is likely to be the case particularly for locks used on doors) the lock may be provided with a key cylinder for one or both sides of the lock (i.e. for one or both sides of the door). And in embodiments which included at least one key cylinder, the lock may further include a locking component which can be moved, by operation of the key cylinder (or by operation of one or either of the key cylinders), from an un-locking position to a locking position. When the locking component is in the unlocking position, it may not prevent the drive member from moving from the first position to the second position, but in the locking position the locking component may prevent the drive member from moving from the first position to the second position. Accordingly, when the locking component is in the locking position, this may prevent retraction of the latch bolt by either of the lock's handles. The locking component may also be moved, by operation of the key cylinder (or by operation of one or either of the key cylinders), from the locking position to the un-locking position to unlock the lock. There is no limitation on the form or configuration that the locking component could take. The locking component could therefore take any suitable form or configuration. One example configuration is given with reference to the drawings below. However, it is to be clearly understood that this is merely one example and myriad other examples are also possible.

In embodiments relating to a lock having one or more key cylinders, it may be possible to move the drive member from the first position to the second position by operation of the key cylinder. Therefore, it may be possible to use the key cylinder (or one or other of the key cylinders) to retract the latch bolt. In embodiments which include one or more handles, this may therefore provide an additional means for attracting the latch bolt. However, in embodiments which did not include handles, this may be the only way in which the latch bolt can be retracted. Furthermore, in embodiments where the handle is provided on one side only, but the other side includes a key cylinder, this may be the only way to retract the latch bolt from the side which has a key cylinder but no handle.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective illustration of a lock in accordance with an embodiment of the invention.

FIG. 1a is a perspective illustration of the cutaway portion of the door to which the lock in FIG. 1 is mounted.

FIG. 2 is partially exploded view of the lock.

FIG. 3 illustrates fasteners required to install the lock on a door as shown in FIG. 1.

FIG. 4 shows the strike plate.

FIG. 5 illustrates the spindle assembly which extends between the inside and outside handles of the lock.

FIG. 6 is an illustration of the inside handle assembly viewed from the same perspective as it is shown in FIGS. 1 and 2.

FIG. 7 also illustrates the inside handle assembly, but from the other side compared with FIG. 6 (i.e. FIG. 7 shows the inside handle assembly but from the side that would not normally be visible when the inside handle assembly is mounted to the door).

FIG. 8 shows the inside handle assembly from the same perspective as FIG. 7, but in FIG. 8 several parts of the assembly are exploded relative to the rest of the assembly.

FIG. 9 is an exploded view of the inside handle and the components used to secure it to the inside housing.

FIG. 9a illustrates the way in which the handle spring is mounted relative to the drive cam when the inside handle is mounted to the inside handle housing.

FIG. 10 illustrates the inside handle assembly and the latch bolt assembly when the latch bolt is in the latching position and the lock is unlocked and un-snibbed.

FIG. 11 shows the inside handle assembly and the latch bolt when the latch bolt has been retracted into the unlatching position by operation of the (inside or outside) lock handle.

FIG. 12 shows the inside handle assembly and the latch bolt assembly when the latch bolt has been retracted into the unlatching position by operation of the (inside or outside) key cylinder.

FIG. 13 illustrates components of the inside handle assembly which are mounted within the inside handle housing. Note, however, that the inside handle housing itself is not shown. This is so that the components housed inside the housing can be seen from this point of view (if the housing were shown the components which are visible would otherwise be blocked from view).

FIG. 14 is an exploded view of the latch bolt assembly.

FIGS. 14a and 14b illustrate the latch bolt assembly fully assembled, but in these Figures the latch housing is shown transparently to reveal the components housed therein.

FIG. 15 is an exploded view of the components which make up the snib mechanism.

FIG. 16 is an exploded view of the inside handle assembly's key cylinder.

FIG. 17 is a partial view of the inside handle assembly (the top portion of the inside handle assembly) illustrating the snib mechanism in the “snibbing” condition.

FIG. 18 is a partial view of the inside handle assembly (the bottom portion of the inside handle assembly) when the locking component is in the locking position.

FIG. 19 illustrates the way the handing stop button can be depressed to enable the handedness of the handle assembly (the inside handle assembly in this case) to be switched.

FIG. 20 illustrates the outside handle assembly, but viewed from the other side compared with the side of the outside handle assembly which is visible in FIG. 2.

FIG. 21 also illustrates the outside handle assembly, and in FIG. 21 the outside handle assembly is shown in the same orientation as it is shown in FIG. 2. Note that FIG. 21 shows the outside handle assembly from the side that would not normally be visible when the outside handle assembly is mounted to the door.

FIG. 22 is an exploded view of the outside handle assembly and its components.

FIGS. 23a to 23h illustrate stages in the installation of the lock on a door.

FIG. 24 relates to a possible alternative lock embodying the present invention.

### DETAILED DESCRIPTION OF THE DRAWINGS

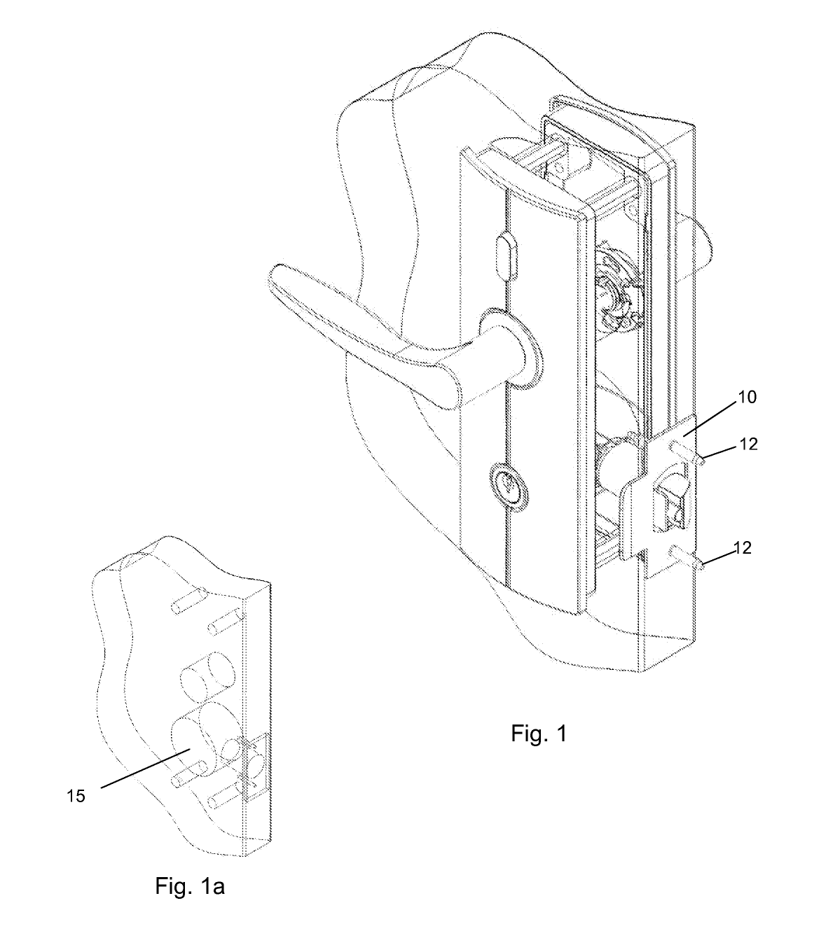

As mentioned above, FIG. 1 is a perspective illustration of a lock in accordance with an embodiment of the invention. In FIG. 1, the lock is shown mounted to a door. Only a cutaway portion of the door is shown in FIG. 1. The cutaway portion of the door is also shown transparently in FIG. 1 such that some internal components of the lock are visible. The cutaway portion of the door itself is shown (again transparently) in FIG. 1a.

FIG. 1 also shows the strike plate 10. The side of the strike plate 10 visible in FIG. 1 is actually the rear of the strike plate. In other words, it is the side of the strike plate that contacts the door frame (door jamb) when the strike is screwed to the door frame using the screws 12 (illustrated in FIG. 3). The side of the strike plate 10 that faces away from the door frame (towards the lock) when the strike is screwed to the door frame is illustrated in FIG. 4.

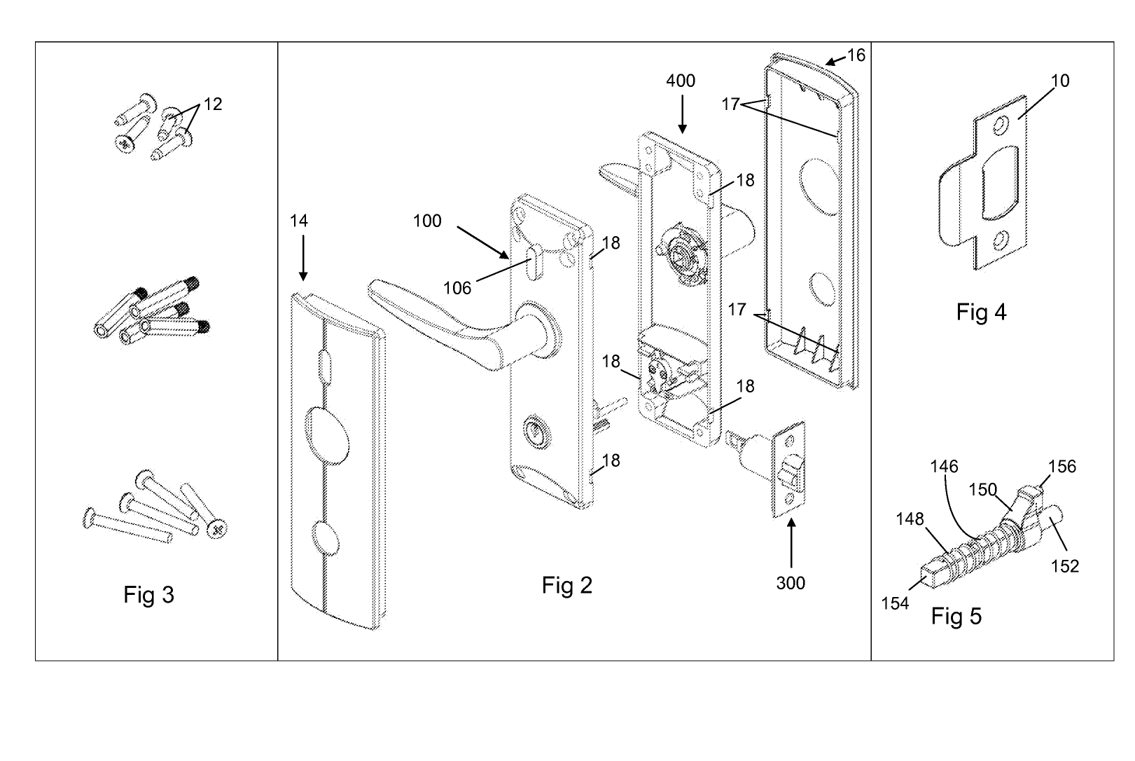

In FIG. 2, the cutaway portion of the door is omitted (along with certain other components including the strike plate, several fasteners, etc) and the major assemblies of the lock are shown separated (exploded) relative to each other. The major assemblies of the lock illustrated in FIG. 2 are the inside handle assembly 100, the outside handle assembly 400, the latch bolt assembly 300, the internal furniture cover 14 and the external furniture cover 16.

In this particular embodiment, the furniture covers 14 and 16 are plastic covers which snap-fit onto the respective internal and external handle assemblies after the assemblies have been secured on the relevant sides of the door. The furniture covers 14 and 16 give the finished lock the desired appearance. The furniture covers 14 and 16 may therefore be coloured/textured/shaped etc as desired (the furniture covers therefore need not necessarily look the same as they appear in FIG. 2). It can be seen from FIG. 2 that the furniture covers have a number of small detents 17 on the inside of their sidewalls, and these detents are received in corresponding notches 18 in the sides of the respective handle assemblies. This is how the furniture covers snap or clip onto the handle assemblies in this embodiment. Both furniture covers 14 and 16 also have holes for accommodating the handles and key cylinders (and the inside furniture cover 14 also has an additional hole for the snib button 106).

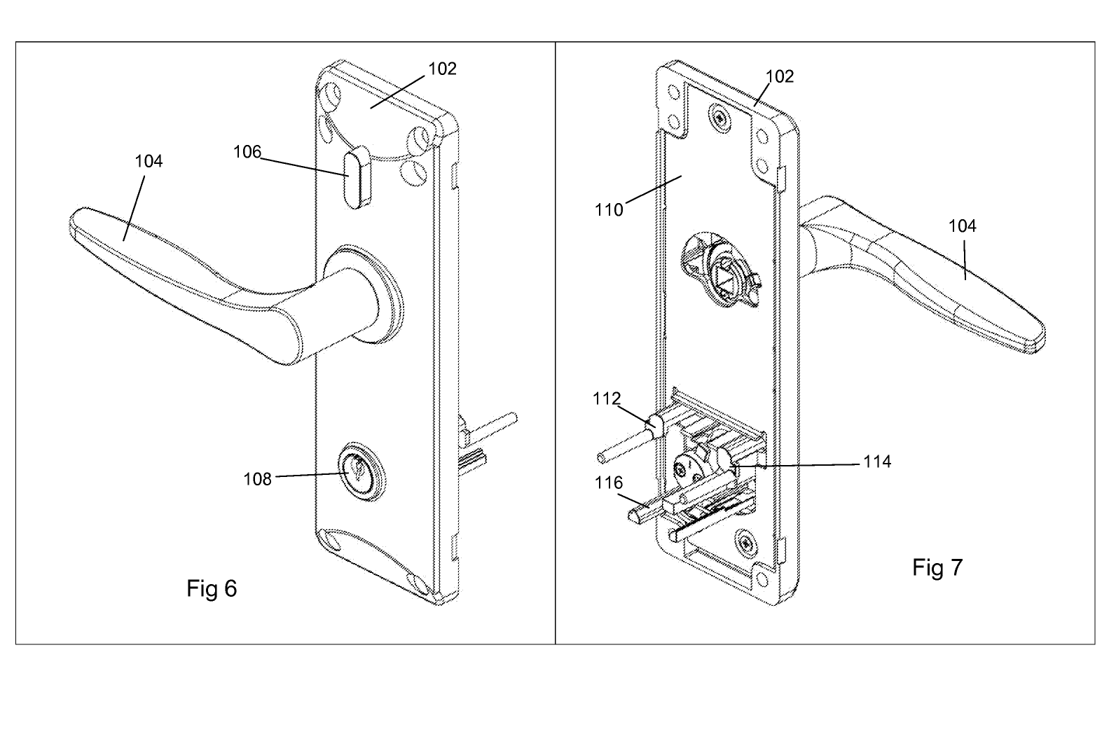

The parts and components that make up the inside handle assembly 100 will initially be described with reference to FIGS. 6-8. From FIG. 6, it can be seen that the inside handle assembly 100 includes a main housing 102, an inside handle 104 mounted for pivotal movement relative to the housing 102, a snib button 106 and a key cylinder 108 into which a user can insert and turn a key (not shown) to operate the lock.

FIG. 7 shows the inside handle assembly 100 from the opposite side to FIG. 6 and illustrates the following additional components, namely an internal backplate 110, a first drive rod 112, a second drive rod 114 and a locking component 116. The internal end of the key cylinder 108 and internal parts of the handle assembly are also partly visible in FIG. 7. These components will be described in greater detail below.

The main function of the back plate 110 is to cover and retain the numerous components which form part of the inside handle assembly 100 between the backplate 110 and the housing 102.

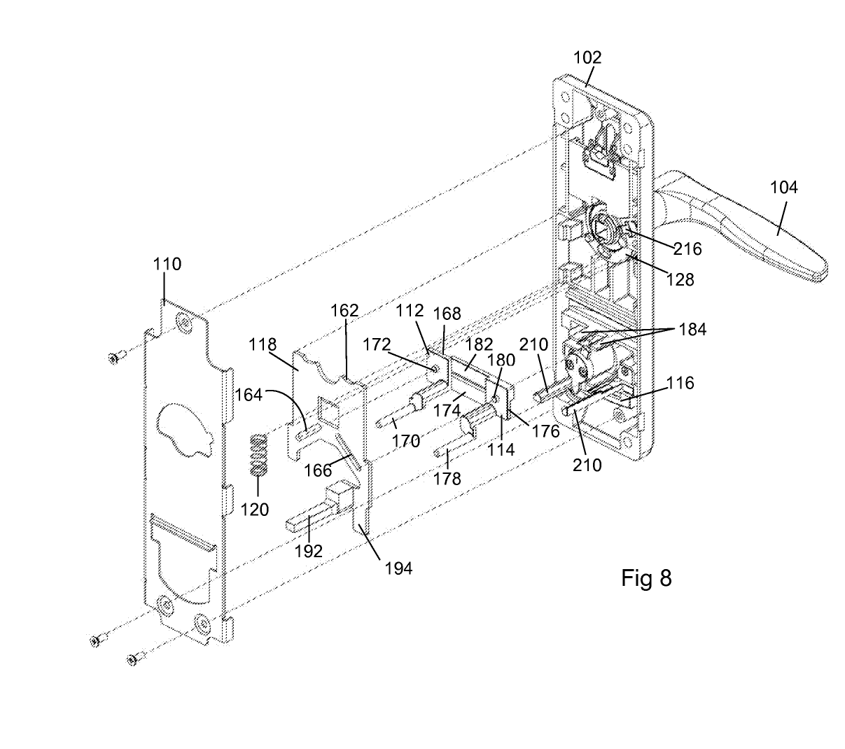

FIG. 8 illustrates the backplate 110 and several other components exploded relative to the rest of the inside handle assembly 100. One of the other components shown exploded relative to the assembly in FIG. 8 is the drive plate 118. The features of the drive plate 118, and their functions, will be discussed further below. Also shown exploded relative to the inside handle assembly 100 in FIG. 8 are the drive plate spring 120 (which, when assembled, is actually positioned between the drive plate 118 and the housing 102 and biases the drive plate 118 towards a naturally upward first position within the housing 102), the first drive rod 112 and the second drive rod 114. The features of the respective drive rods, and their functions, will be discussed below.

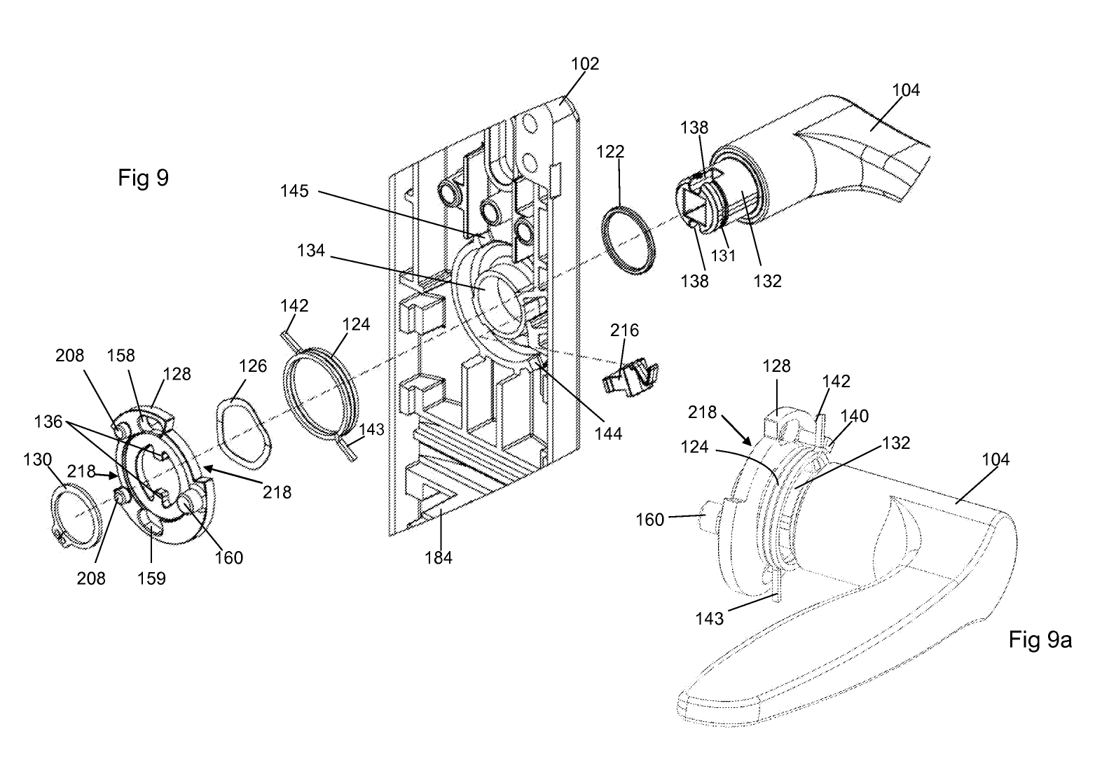

FIG. 9 is a close-up exploded view of the components associated with the handle 104 and it's mounting to the housing 102. These components include a washer 122, a handle return spring 124, a wave washer 126, a drive cam 128 and a handle retaining circlip 130. When the handle 104 is mounted to the housing 102, the plug-like portion 132 on the inward end of the handle 104 inserts through the handle hole 134 in the housing 102. The washer 122 is placed over the plug portion 132 before the plug portion 132 is inserted through the hole 134 such that the washer 122 becomes positioned between the housing 102 and the handle 104 on the outside of housing. The plug portion 132 extends through the hole 134 into the inside of the housing. On the inside of the housing, the spring 124, wave washer 126, and drive cam 128 are mounted on the plug portion 132 as can be understood from FIG. 9 and are all secured thereon by the circlip 130. The circlip 130 is received in a groove 131 which extends around the circumference of the plug portion 132. When the circlip 130 is received in the groove 131, the circlip 130 is prevented from being pushed off the end of the plug portion 132. The circlip 130 therefore retains the drive cam 128, spring 124, etc, on the plug portion 132, and it also thereby secures the handle 104 to the housing 102 (because the plug portion 132 with the other components secured thereon cannot then be withdrawn back out of the handle hole 134).

When the drive cam 128 is mounted on the plug portion 132 of the handle as described above, inwardly pointing posts 136 (which project into the central opening in the drive cam 128) insert into notches 138 cut in the top and bottom of the plug portion 132 of the handle. Consequently, rotation of the handle 104 always causes corresponding rotation of the drive cam 128. In other words, when the handle 104 and the drive cam 128 are assembled together, they rotate effectively as a single component and one cannot rotate at all without causing corresponding rotation of the other.

FIG. 9a illustrates the way the drive cam 128 and the spring 124 mount on the plug portion 132 of the handle 104. This is, in fact, how the drive cam 128 and the spring 124 mount on the plug portion 132 when the plug portion 132 inserts through the handle hole 134 to mount the handle 104 to the housing 102 (the housing 102 is not shown in FIG. 9a and this so that the drive cam 128 and spring 124 can be seen from this perspective).

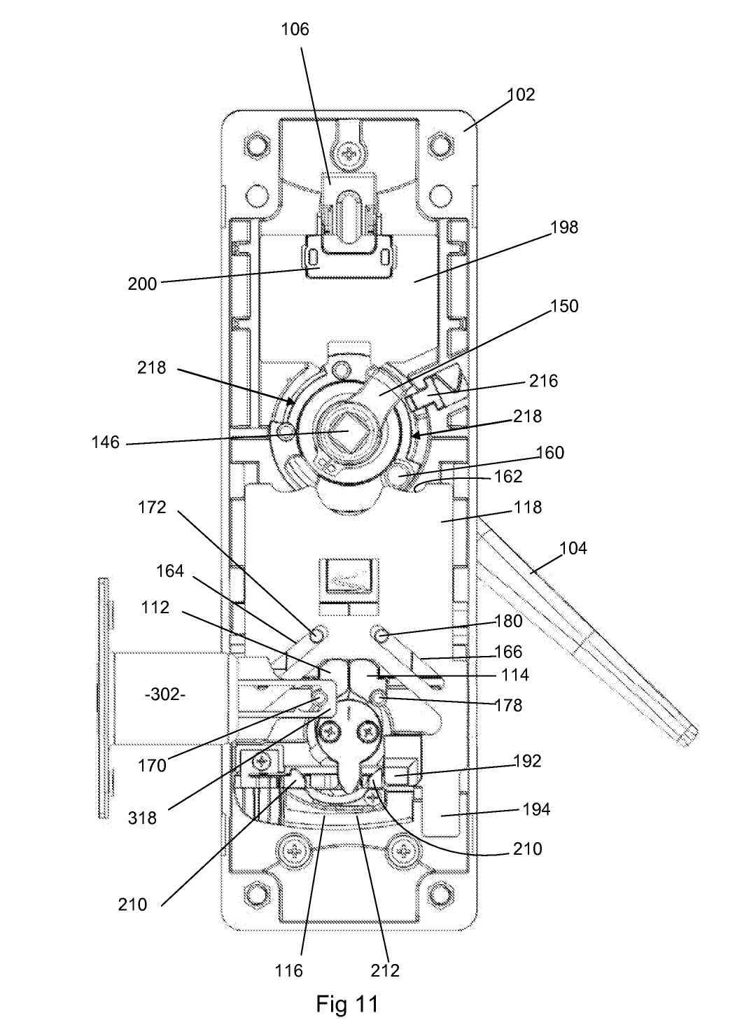

From FIG. 9a, it can be seen that there is a post 140 projecting from the rear of the drive cam 128. It can also be seen that the handle return spring 124 is mounted such that one of its outwardly-pointing straight portions 142 is positioned in front of, and engages, the post 140. The other straight portion 143 of the spring engages a flat surface 144 on the housing 102 (recall that even though the housing 102 is not shown in FIG. 9a, this Figure nevertheless shows the configuration of the drive cam 128 and spring 124 relative to the handle 104 when the handle 104 is mounted to the housing 102). The flat surface 144 of the housing is illustrated in FIG. 9. When the handle 104 is rotated by a user to operate the lock (e.g. as shown in FIG. 11) the drive cam 128 rotates with the handle 104 and this causes the post 140 to push against the straight portion 142 of the spring, which in turn causes the spring 124 to deflect in a rotary manner against its natural bias. When the handle is released, the spring 124 (and in particular the straight portion 142) pushes back against the post 140 due to the spring's natural bias, thereby causing the handle to rotate back into its original un-rotated position.

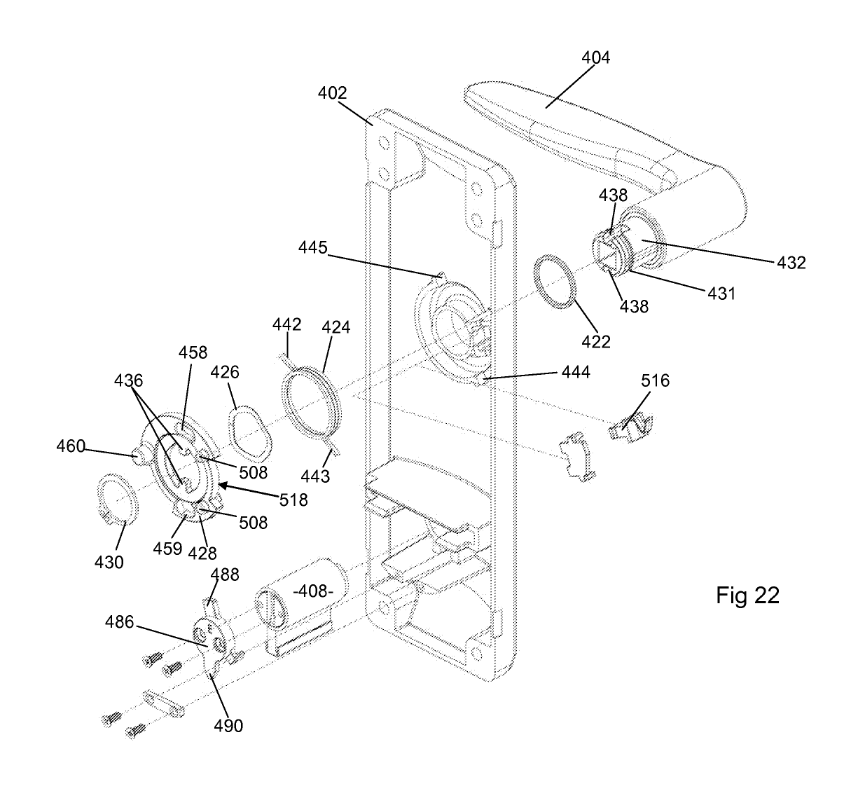

FIG. 5 illustrates the spindle assembly. The spindle assembly includes a spindle 146, and mounted on the spindle 146 there is a compression spring 148 and a spindle component 150. The spindle component 150 is fixed on the spindle 146 (i.e. the spindle component 150 rotates effectively as one with spindle 146 and cannot rotate relative to the spindle 146). The spindle 146 has an inside end 152 and an outside end 154. The spindle component 150 is mounted towards the inside end 152 of the spindle. The inside end 152 of the spindle is round and smaller in size than the square opening in the plug portion 132 of the inside handle 104. Therefore, when the lock is assembled, the inside end 152 of the spindle 146 inserts into the square opening in the plug portion 132 of the inside handle, but the inside end 152 of the spindle does not engage with the sides of the square opening. The outside end 154 of the spindle 146 is square and is sized to fit snugly in the square opening in the plug portion of the outside handle (see FIGS. 21 and 22). Therefore, when the lock is assembled, the outside end 154 of the spindle 146 inserts into, and engages with, the square opening in the plug portion of the outside handle such that the outside handle and the spindle 146 rotate effectively as one (i.e. the outside handle cannot rotate without rotating the spindle 146, and vice versa).

The compression spring 148 functions to bias the spindle assembly away from the outside handle, and thereby biases the spindle component into engagement with the drive cam 128, as discussed below.

As mentioned above, the spindle component 150 is fixedly mounted on the spindle 146 such that the spindle component 150 cannot rotate relative to the spindle 146. The spindle component 150 also engages with the drive cam 128. Specifically, the spindle component 150 has a lug 156 on the upper portion thereof pointing in the same direction as the inside end 152 of the spindle. When the lock is assembled, the lug 156 inserts into an oval shaped opening 158 in the drive cam 128 (see FIG. 9). It should also be recalled that the inwardly pointing posts 136 on the inside of the drive cam 128 insert into notches 138 in the top and bottom of the inside handle's plug portion 132 such that rotation of the handle 104 causes corresponding rotation of the drive cam 128. Therefore, because the lug 156 on the spindle component 150 is received in the opening 158 in the drive cam, when the drive cam 128 rotates due to rotation of the handle 104, the side of the opening 158 pushes against the lug 156, thereby causing the spindle component 150 (and hence the spindle 146) to rotate. This is how rotation of the inside handle 104 is transmitted to cause rotation of the spindle 146.

It should be noted, however, that the lug 156 on the spindle component 150 is round, whereas the opening 158 in the drive cam 128 is oval shaped. Therefore, there is a small amount of “play” (or “lost motion”) between the drive cam 128 and the spindle component 150. In other words, it is possible for the drive cam 128 (and the handle 104) to rotate a small initial amount before the side of the opening 158 engages with the lug 156. This initial “lost motion” rotation of the handle therefore does not cause corresponding rotation of the spindle. The purpose of this configuration which allows a small amount of lost motion will be explained below.

It should also be noted the drive cam 128 has another oval shaped opening 159 (in addition to the oval shaped opening 158). The opening 159 is the same shape as the opening 158, and the opening 159 is located almost (but not exactly) opposite the opening 158 on the other side of the drive cam 128. In other words, the opening 159 is separated from the opening 158 by almost (but not exactly) 180°. The opening 159 is provided because the inside handle assembly 100 can be configured as either left-handed or right-handed (the same is true of the outside handle assembly 400). The handle assemblies are always configured into the intended handedness (left-handed or right-handed) before being mounted together with the other components and installed on the door.

In the Figures, the inside handle assembly 100 is shown in a left-handed configuration (and the outside handle assembly 400 is shown in a right-handed configuration). Referring to the inside handle assembly 100, when the inside handle assembly 100 is configured to be left-handed (as shown), the opening 158 in the drive cam 128 is oriented towards the top of the housing 102 and the opening 159 is oriented towards the bottom of the housing. Also, when the lock is assembled (and this is true in either handedness) the spindle assembly is always oriented such that the spindle component 150 points vertically upwards relative to the spindle 146. Accordingly, when the inside handle assembly 100 is arranged to be left-handed and is assembled with the spindle and mounted to the door, the lug 156 on the spindle component 150 inserts into the oval shaped opening 158 in the drive cam 128 (because in this handedness the opening 158 is oriented towards the top of the housing). However, if the inside handle assembly 100 were alternatively arranged to be right-handed before being assembled with the spindle and mounted to the door, the opening 159 in the drive cam 128 would in this case be oriented upwardly (and the opening 158 would be oriented downwardly) and therefore the lug 156 on the spindle component 150 would insert into the opening 159. Further discussion on the way the handle assemblies can be converted from one handedness to the other will be given below.

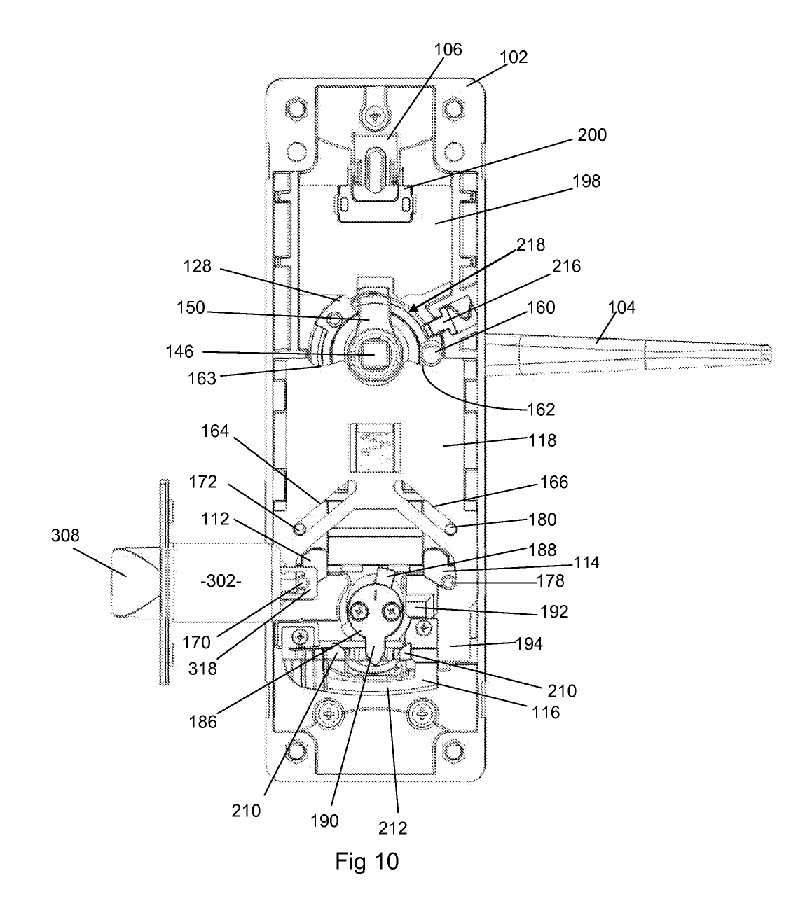

Referring again to FIG. 9, it will be seen that the drive cam 128 further includes a main drive lug 160. The purpose of the main drive lug 160 can be understood from FIGS. 10 and 11. From FIG. 10, it can be seen that when the components are assembled (and when the latch bolt is extended), the main drive lug 160 engages against a slightly concave indent 162 on the top edge of the drive plate 118. (Note that the drive lug 160 would instead engage with the concave indent 163 if the lock were in the other handedness.) It should also be recalled that the handle 104 and the drive cam 128 rotate effectively as one component. Therefore, when the handle 104 is rotated from its rest position (shown in FIG. 10) into its rotated position (shown in FIG. 11), the drive cam 128 also rotates in the same direction by the same amount. This rotation causes the main drive lug 160 to move in an arcuate manner from the position shown in FIG. 10 down into the position shown in FIG. 11. When the main drive lug 160 moves in this way, it pushes down on the top of the drive plate 118 thereby pushing the drive plate 118 downwards from the first position (shown in FIG. 10) into the second position (shown in FIG. 11).

Turning next to consider certain other features of the drive plate 118, and referring to FIG. 8, it can be seen that the drive plate 118 includes two diagonal elongate internal slots, namely a first slot 164 and a second slot 166. The slots 164 and 166 are symmetrical straight sided cutouts in the drive plate 118, and their respective upper ends are located closer together (towards the centre of the drive plate 118) and their respective lower ends are located further apart and lower down the drive plate 118. In this embodiment, both slots 164 and 166 are oriented at approximately 45° to the vertical axis of the lock.

FIG. 8 also illustrates the first drive rod 112 and the second drive rod 114. It should be noted that the first drive rod 112 is a separate component from the second drive rod 114. The two drive rods can therefore move relative to each other, as discussed below.

The first drive rod 112 comprises a plate portion 168, a rod portion 170, a lug 172 and a guide portion 174. The plate portion 168 resembles a substantially square flat plate, and the lug 172 is a round lug formed in the centre of the plate portion 168. The rod portion 170 projects out perpendicular to the plane of the plate portion 168, from the lower inward corner of the plate portion. The rod portion 170 has a stepped configuration and its distal end is shaped as a substantially round rod. The guide portion 174 is a substantially flat rectangular portion which connects on the rear of the plate portion 168 and extends across the space between the two drive rods such that the far end of the guide portion 174 is positioned behind the base of the plate portion on the second drive rod 114.

The second drive rod 114 also comprises a plate portion 176, a rod portion 178, a lug 180 and a guide portion 182. Again, the plate portion 176 resembles a substantially square flat plate, and the lug 180 is a round lug formed in the centre of the plate portion 176. The rod portion 178 projects out perpendicular to the plate portion 176, from the lower inward corner of the plate portion. The rod portion 178 has a stepped configuration and its distal end is shaped as a substantially round rod. The guide portion 182 is substantially flat and rectangular, it connects on the rear of the plate portion 176 and extends across space between the two drive rods such that the far end of the guide portion 182 is positioned behind the top of the plate portion of the first drive rod 112.

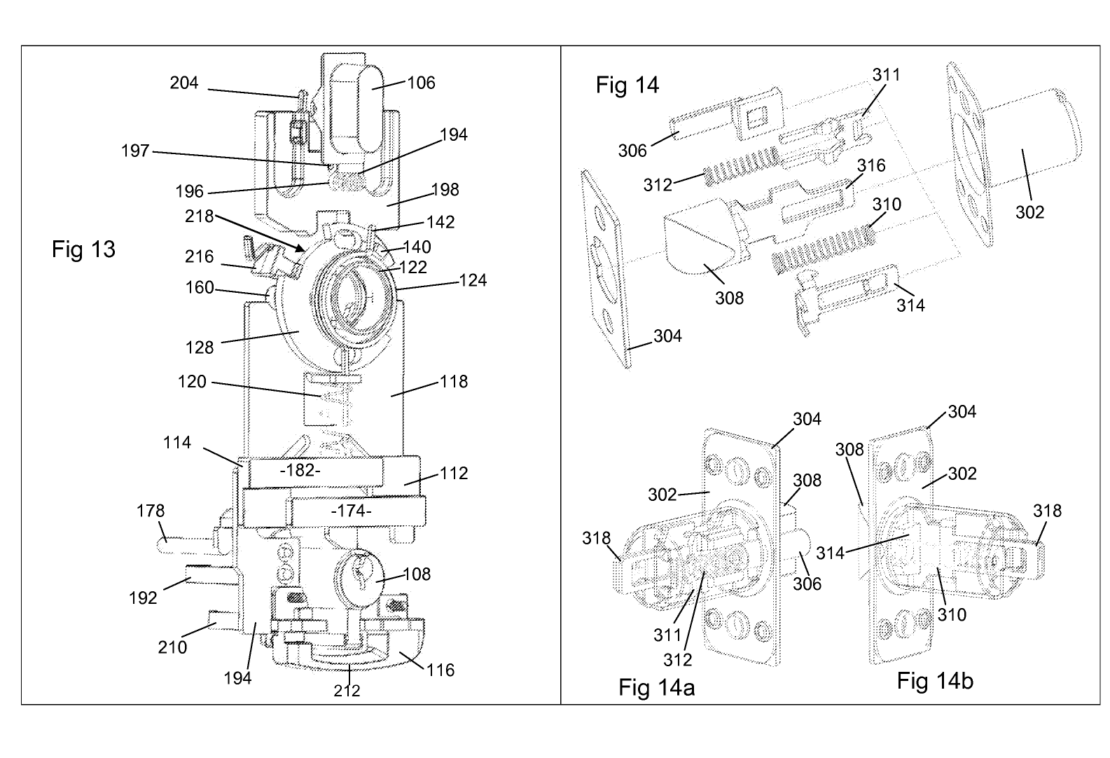

The way that the guide portion of each guide rod is positioned at least partly behind the plate portion of the other guide rod (as illustrated in FIG. 13) helps to ensure that the respective guide rods slide horizontally relative to each other, and prevents the guide rods from twisting within the housing about a vertical axis. The guide portion 174 of the first guide rod 112 also rests on top of a pair of supporting plates 184 which are part of the housing 102 (see FIG. 8) and this helps to prevent the first guide rod 112 from rotating or twisting about a horizontal axis. The guide portion 182 of the second guide rod 114 is positioned above the guide portion 174 of the first guide rod 112, and it fits into, and is guided by, rail features in the housing. Again, this helps to prevent the second guide rod 114 from rotating or twisting. Therefore, significant rotation of the second guide rod 114 in one direction is also prevented as such rotation would causes the guide portion 182 to collide with the guide portion 174 of the first guide rod 112.

Turning again to FIG. 10, it can be seen that when the components are assembled, the lug 172 on the first drive rod's plate portion inserts into the first slot 164 in the drive plate 118. Similarly, the lug 180 on the second drive rod's plate portion inserts into the second slot 166 in the drive plate 118. Therefore, when the handle is rotated forcing the drive plate 118 downwards as described above, the upper diagonal walls of the respective slots 164 and 166 press against the respective lugs 172 and 180. Because of the angle with which the respective upper walls of the slots 164 and 166 bear against the lugs 172 and 180, and because the drive rods 112 and 114 are constrained only to move horizontally, when the drive plate 118 moves from the position shown in FIG. 10 into the position shown in FIG. 11, the respective drive rods 112 and 114 are forced to slide horizontally inward from their position shown in FIG. 10 into their position shown in FIG. 11 (in FIG. 11 it can be seen that the rod portions 170 and 178 are brought closer together). However, as mentioned above, the drive plate 118 is naturally biased by the drive plate spring 120 towards its upper first position. Therefore, when the pressure forcing the drive plate 118 downwards is released, the spring 120 forces the drive plate 118 to move back upwards into the first position. When this happens, the lower walls of the slots 164 and 166 bear against the lugs 172 and 180 forcing the drive rods 112 and 114 to slide horizontally outwards (i.e. forcing the drive rods to slide apart) from their positions shown in FIG. 11 into their positions shown in FIG. 10.

The latch bolt assembly 300 is illustrated in several Figures, including FIGS. 2, 10 and 11. An exploded view of the latch bolt assembly 300 is also given in FIG. 14. FIGS. 14a and 14b illustrate the latch bolt assembly 300 fully assembled, but in these Figures the latch housing is shown transparently to reveal the components housed therein.

From FIG. 14, it can be seen that the latch assembly 300 includes the latch housing 302, the latch front plate 304, the auxiliary latch bolt 306, the main latch bolt 308, the main bolt spring 310, the latch pivoter 311, the pivoter spring 312 and the latch kick plate 314. The way in which these components go together when the latch assembly 300 is assembled can be seen from FIGS. 14a and 14b and need not be explained in detail. Those skilled in the art will appreciate that when the latch assembly 300 is assembled, the main bolt spring 310 is mounted in a state of compression between the head of the main bolt 308 and the back wall of the latch housing 302. Accordingly, the main bolt 308 is naturally biased towards the latching position where the head of the main bolt 308 projects out of the housing 302 through the central hole in the front plate 304. It will also be appreciated that the auxiliary bolt 306 is similarly biased towards its extended position by the auxiliary bolt spring 312.

When the latch assembly 300 is assembled, the rear end 316 of the main latch bolt 308 and the rear end of the kick plate 314 both project out through an opening in the rear of the latch housing 302. These two components are also aligned so that the respective openings therein (i.e. the opening in the tale of the latch bolt 308 and the opening in the kick plate 314) align to form a closed loop which extends out through the rear of the latch housing. This closed loop (formed by the aligned rear portions of the latch bolt 316 and kick plate 314) is indicated by reference numeral 318 in FIGS. 14a and 14b. It should be noted that this aspect of the design could also work if, for example, instead of forming a closed loop projecting from the rear of the latch housing, the said components instead formed an open hook or the like projecting from the back of the latch housing.

In any case, in the drawings, the closed loop 318 which extends from the rear of the latch assembly is also visible in FIGS. 10 and 11. FIGS. 10 and 11 further illustrate that when the latch assembly 300 is mounted together with the inside handle assembly 100 in the left-handed configuration shown, the round distal end of the rod portion 170 of the first drive rod 112 inserts through the closed loop 318 on the back of the latch assembly 300. Therefore, when the handle 104 is rotated (as shown in FIG. 11) causing the drive rods 112 and 114 to slide horizontally inwards as explained above, the inward movement of the first drive rod 112 causes the closed loop on the rear of the latch assembly to be drawn inward as illustrated in FIG. 11. This in turn causes the latch bolts to be retracted (against the bias of springs 310 and 312) from the extended latching position shown in FIG. 10 into the retracted unlatching position shown in FIG. 11. This is therefore how the latch bolt 308 (and also the auxiliary bolt 306) is retracted by operation of the handle 104. Note that it is a condition that the system is in an unlocked state for this operation to be possible.

It should be stressed that, in the Figures, the inside handle assembly 100 is shown in a left-handed configuration. The inside handle assembly can also be reconfigured to adopt a right-handed configuration. By way of example, in FIGS. 10 and 11, if the inside handle assembly were instead in a right-handed configuration, the handle 104 would be oriented in the opposite direction (i.e. it would extend out to the left in the orientation shown in FIGS. 10 and 11). The reason why the inside handle assembly 100 might be reconfigured to adopt a right-handed configuration would be to enable it to be used as the inside handle on a door which is hinged on the opposite side. Accordingly, if the inside handle assembly were instead configured in a right-handed configuration for use on an oppositely hinged door, the latch assembly 300 would also necessarily need to point in the opposite direction (i.e. it would be positioned to extend out to the right in the orientation shown in FIGS. 10-12) so as to extend from the free edge of the door opposite the hinge. The curved sloping face on the head of the latch bolt 308 may also need to be oriented to face the other way in some configurations (e.g. to face into the page rather than out of the page in FIG. 10) depending on whether the door swings open inwards or outwards. This can be achieved by simply flipping the latch assembly over prior to installation.

In any case, if the latch assembly 300 were to instead point in the opposite direction to that shown in FIGS. 10 and 11, the round distal end of the rod portion 178 on the second drive rod 114 (rather than the rod portion 170 of the first drive rod 112) would insert through the closed loop 318 on the back of the latch assembly 300. And, if the handle 104 were rotated causing the drive rods 112 and 114 to slide horizontally inwards, the inward movement of the second drive rod 114 would cause the closed loop on the rear of the latch assembly to be drawn inward. As above, this would in turn cause the latch bolts to be retracted from the extended latching position into the retracted unlatching position.

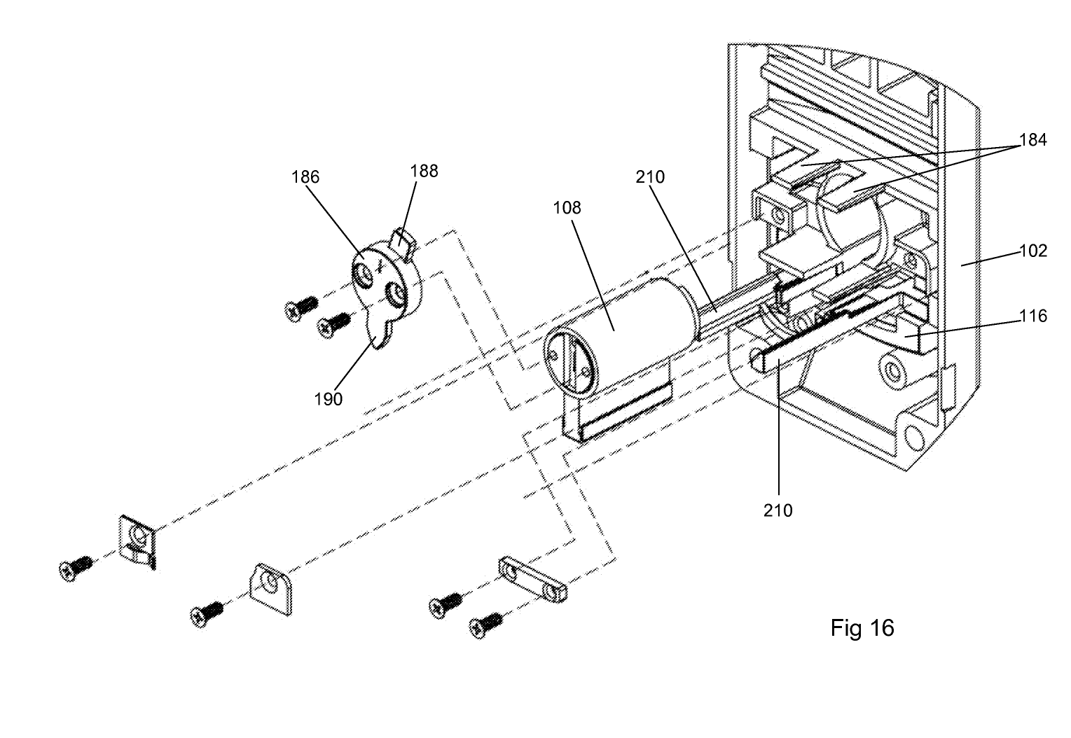

It is also possible to retract the latch bolts (i.e. to move the latch bolts from the latching position to the unlatching position) by operating the key cylinder 108. The key cylinders in both the inside handle assembly 100 and the outside handle assembly 400 are the same, and they have a generally conventional form. Therefore, a user can insert a key (not shown) into the key cylinder, and the key can be turned therein to operate the cylinder. The inner end of the inside handle assembly's key cylinder 108 (i.e. the end of the key cylinder 108 within the inside handle assembly) is illustrated in FIG. 16 which is an exploded view of the key cylinder 108. As shown in FIG. 16, a component (referred to hereinafter as the locking cam 186) is mounted on the inside end of the key cylinder 108. The locking cam 186 is a generally round component and it is secured to the end of the key cylinder by two screws (as shown in FIG. 16). As a result, when a key is inserted into the key cylinder 108 and turned, the locking cam 186 on the inside end of the key cylinder rotates by the same amount as the key. It can also be seen from FIG. 16 that the locking cam 186 has a latching post 188 projecting from one side thereof, and a locking post 190 projecting from its other side approximately (but not exactly) opposite the latching post 188. The latching post 188 is generally square/rectangular in shape. The locking post 190 is slightly longer than the latching post 188 and tapers to a rounded point at its distal end. A number of other screws and mounting components are shown exploded relative to the key cylinder 108 and the housing 102 in FIG. 16. These components operate mostly to mount the key cylinder to the housing, and therefore need not be discussed in detail.

Referring next to FIG. 8, and in particular to the drive plate 118, it can be seen that on one side of the drive plate 118 there is a portion which extends downward toward the bottom of the lock. Mounted on this downwardly extending portion of the drive plate 118 is a rectangular pillar 192. The pillar 192 extends out perpendicular to the plane of the drive plate 118. The lowermost end of the downwardly pointing portion of the drive plate also forms a tab portion 194. The functions of the pillar 192 and the tab 194 will be explained further below.

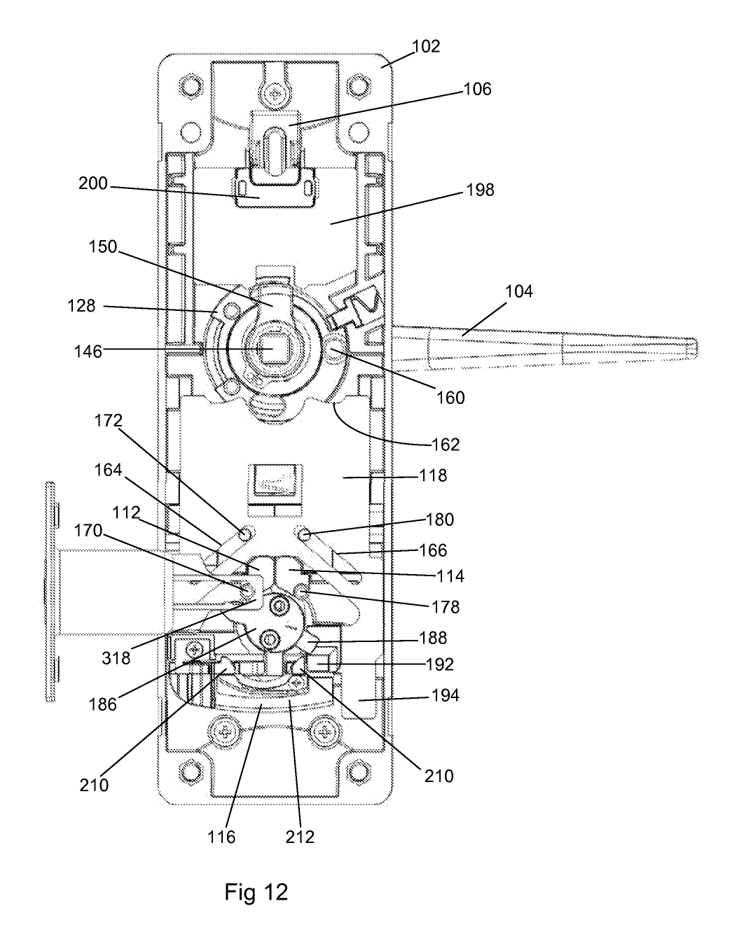

As mentioned above, it is possible to retract the latch bolts (i.e. to move them from the latching position to the unlatching position) by operating the key cylinder 108. The way this is done can now be understood with reference to FIGS. 10 and 12. In FIG. 10, the locking cam 186 on the inner end of the key cylinder 108 is visible, and it is shown in the orientation it adopts before a key is inserted and turned in the key cylinder. However, if the key is inserted into the key cylinder and rotated in one direction, this in turn causes the locking cam 186 to rotate from the position shown in FIG. 10 into the position shown in FIG. 12. When the locking cam 186 rotates in this manner, the latching post 188 initially moves into contact with the horizontally extending pillar 192 (which is connected to/part of the drive plate 118). With further rotation of the locking cam 186, latching post 188 forces the pillar 192 downwards in the lock, thereby causing the whole drive plate 118 to move downward from the position shown in FIG. 10 into the position shown in FIG. 12. Note that the position of the drive plate 118 in FIG. 12 is the same as the position of the drive plate 118 in FIG. 11. However, in FIG. 11, the drive plate was driven down by operation of the handle 104, whereas in FIG. 12 the drive plate has been driven down by operation of the key cylinder 108. As explained above, when the drive plate 118 is forced downwards in the lock, this causes the drive rods 112 and 114 to be driven inwards, thereby causing the latch bolts to be retracted.

It should be noted that the length of the pillar 192 is such that, when the lock is fully assembled on the door, the pillar 192 extends at least most of the way across the gap between the inside handle assembly 100 and the outside handle assembly 400. The pillar 192, and certain other components which extend across this gap, extend through the main cylindrical hole 15 in the door (see FIG. 1a). Because the pillar 192 extends at least most of the way across the said gap, it is possible for the locking cam on the inner end of the outside handle assembly's key cylinder to also engage with the pillar. The locking cam on the outside handle assembly's key cylinder is illustrated in FIGS. 2, 21 and 22. In any case, because the locking cam of the outside handle's key cylinder can engage with the pillar 192, it is possible to retract the latch bolt in exactly the same manner as explained in the previous paragraph by operating the outside key cylinder.

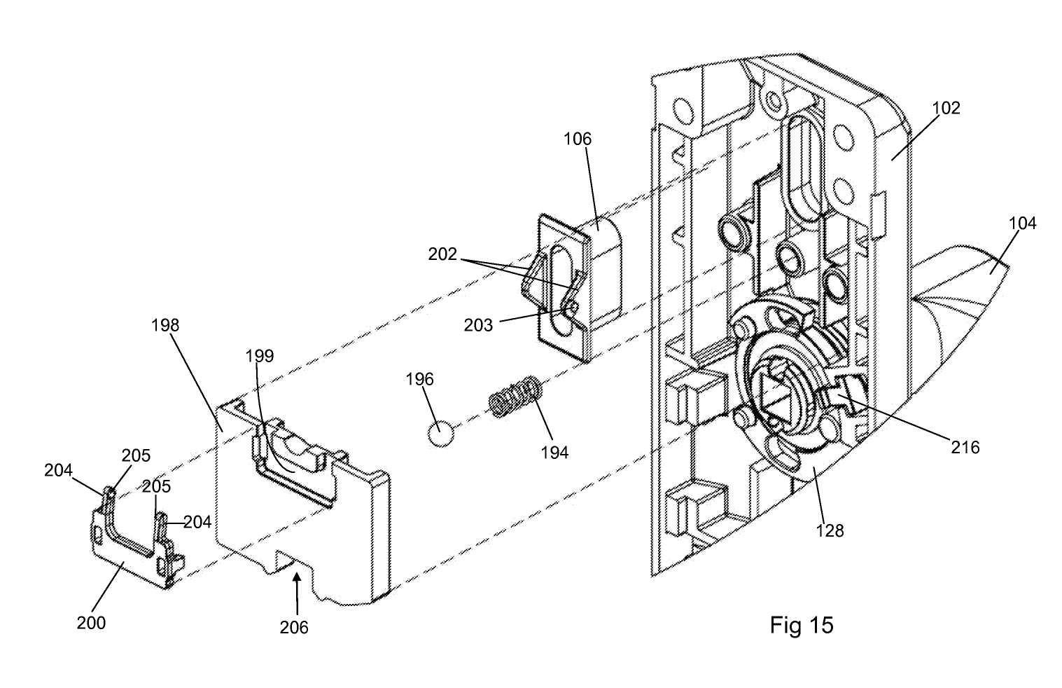

The inside handle assembly 100 further incorporates a snib mechanism. The snib mechanism functions such that, when the snib mechanism is engaged, the lock is placed in a state in which it is not possible to operate the outside handle to retract the latch bolt. The components which make up the snib mechanism are shown exploded relative to the housing 102 in FIG. 15. The components include a snib button 106, a snib detent spring 194, a snib detent ball 196, a snib plate 198 and a snib retainer 200.

As illustrated in FIGS. 1, 2 and 6, when the inside handle assembly 100 is fully assembled, part of the snib button 106 projects out through a slot-shaped opening in the housing 102 (and also through a similar opening in the furniture cover 14) such that the snib button 106 is accessible from outside the lock on the inside of the door. The snib mechanism is operated by pushing the snib button 106 in.

Referring next to FIG. 15, it can be seen that on the internal end of the snib button 106 there is a pair of triangular ramp portions 202. The ramp portions 202 are (and indeed the entire snib button 106 is) symmetrical about the horizontal centreline thereof. The snib button 106 can therefore be inserted either way up when the inside handle assembly 100 is assembled. It can also be seen from FIG. 15 that there is an indented recess 199 in the top of the snib plate 198. The recess 199 is shaped to receive the snib retainer 200. That is, when the snib mechanism is assembled, the snib retainer 200 is received in the recess 199 (this is evident from FIG. 15 and is shown in FIG. 10-12). The snib retainer 200 has a pair of upwardly-pointing arms 204. When the snib mechanism is assembled with the snib retainer 200 inserted in the recess 199 in the snib plate, the upwardly pointing arms 204 extend above the top of the snib plate 198. This can be seen most clearly in FIG. 13.

At the top of each of the respective arms 204, on the inwardly-facing surface thereof (i.e. at the top of the surface of each arm 204 that faces towards the other arm 204) there is a bump 205. The bump 205 on the top of each arm 204 can just be made out in FIG. 15. Also, at the apex of each of the triangular ramp portions 202 on the snib button 106, and on the outwardly-facing sides of the respective ramp portions 202, there is a notch 203. The notches 203 on the apexes of the ramped portions 202 are configured to engage with the respective bumps 205 on the arms of the snib retainer 200. This is discussed further below.

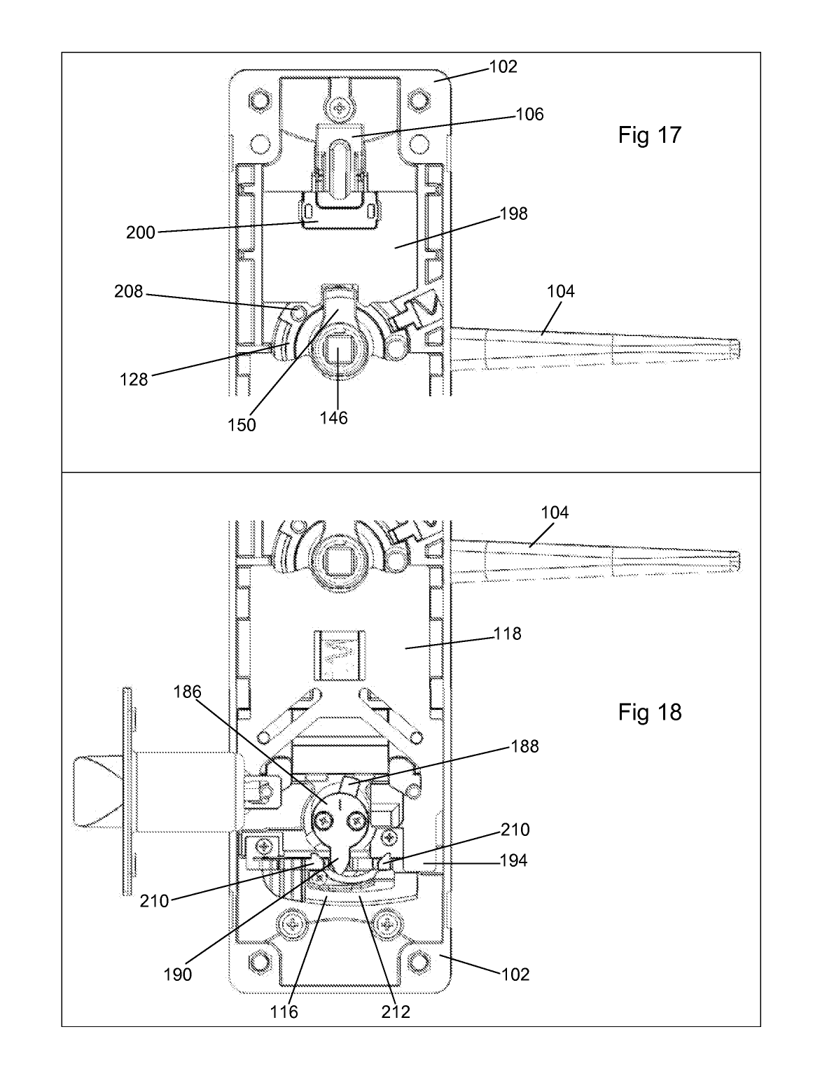

As mentioned above, when the lock is assembled, the snib mechanism is operated by pushing the snib button 106 in. In other words, by pushing the button 106 from outside the lock (on the inside of the door) so that the button 106 moves into the housing 102, and such that the flat exterior face of the button 106 becomes flush (or approximately flush) with the exterior surface of the furniture cover 14. When the button 106 moves inwards in this way, on the inside of the housing 102, the lower angled edges of the respective ramp portions 202 engage against the top edge of the snib plate 198. Because of the angle at which the angled edges of the ramp portions 202 engage with the top edge of the snib plate, as the button 106 is pushed progressively inwards, the snib plate 198 is forced to slide progressively vertically downwards in the lock. In other words, pushing the button 106 in causes the snib plate 198 to be forced down in the lock, from the un-snibbing position shown in FIGS. 10-12 into the snibbing position shown in FIG. 17.

When the button 106 is pushed all the way in, thus moving the snib plate 198 down into the snibbing position, the notches 203 on the respective apexes of the ramp portions 202 engage (friction fit) with the bumps 205 on the respective ends of the arms 204 of the snib retainer 200. This engagement retains the button 106 in the “pushed-in” position. In other words, it prevents the snib button 106 from being able to move back out, or rattle between its inward and outward positions, while the lock is “snibbed”.

FIG. 13 shows, amongst other things, the back edge of the snib plate 198 (i.e. the opposite side of the snib plate to that shown FIGS. 10-12 and 17 etc). In FIG. 13, the snib plate 198 is shown in its upward un-snibbing position. From FIG. 13, it can be seen that on the back of a snib plate 198 there are a pair of round holes 197. In the Figure, the detent ball 196 is being forced into engagement with the lower of these holes by the detent spring 194 (so the lower hole is not actually visible or labelled). The other (upper) of the holes 197 is visible in FIG. 13 just above the detent ball 196. In this configuration (i.e. when the snib plate 198 is in the upward un-snibbing position) the force of engagement between the detent ball 196 and the lower hole 197 helps to prevent the snib plate 198 from sliding downwards in the lock (e.g. due to gravity). However, when the snib button 106 is pushed in to thereby force the snib plate 198 downwards, the detent ball 196 moves out of engagement with the lower hole and into engagement with the upper hole 197. This then helps to retain the snib plate 198 in the lower snibbing position. The engagement of the detent ball 196 with the upper hole 197 when the snib plate 198 moves into the snibbing position also provides the user with “feel” (or an audible “click” or some other tactile or audible response) to confirm that the lock is “snibbed”.

Turning into FIG. 15, it can be seen that the lower edge of the snib plate 198 incorporates a rectangular indent or channel 206. As shown in FIG. 17, when the snib plate 198 moves down into the snibbing position, the spindle component 150 (which is mounted on the spindle 146) becomes positioned between the parallel sidewalls of the channel 206. This captures the spindle component 150 and prevents the spindle component 150 from rotating (e.g. it prevents the spindle component 150 from rotating in the manner shown in FIG. 11). It should also be recalled that the spindle component 150 is fixedly mounted to (and rotates effectively “as one” with) the spindle 146. Accordingly, when the snib plate 198 moves into the snibbing position shown in FIG. 17, the spindle component 150 and the spindle 146 are prevented from rotating. This in turn prevents the outside handle from rotating because (as it will be recalled) the square outer end 154 of the spindle engages directly with the outside handle so that the outside handle cannot rotate if the spindle cannot rotate. Thus, by pushing the snib button 106 in, the lock is placed in the “snibbed” state where the outside handle cannot be rotated to retract the latch bolt.

To “un-snib” the lock (i.e. to move the snib plate 198 back upwards in the lock and thereby free the outside handle for use) the inside handle 104 must be operated. At this point it is important to recall that there is a small amount of “play” or “lost motion” between the drive cam 128 (which is fixedly connected to, and rotates “as one” with, the inside handle 104) and the spindle component 150. In other words, it is possible for the handle 104 and drive cam 128 to rotate a small initial amount before the side of the opening 158 in the drive cam 128 engages with the lug 156 on the spindle component 150. This initial “lost motion” rotation of the handle 104 and drive cam 128 does not cause corresponding rotation of the spindle 146.

Referring to FIG. 9, it can be seen that the drive cam 128 includes an un-snibbing lug 208. (In fact, there is a pair of un-snibbing lugs 208. One of the un-snibbing lugs is used when the inside handle assembly is in the left-handed configuration, and the other operates when the inside handle assembly is in the right-handed configuration.) Turning to FIG. 17, it will be seen that when the snib plate 198 is in the snibbing position and the handle 104 is un-rotated, the un-snibbing lug 208 on the drive cam 128 is located just beneath the bottom edge of the snib plate 198. Furthermore, it will be appreciated that if the handle 104 is turned by a small amount (e.g. if it is turned in the same direction as in FIG. 11 but by a fraction of the amount), this small initial rotation causes the un-snibbing lug 208 to press upward against the underside of the snib plate 198, and this in turn drives the snib plate 198 upwards. The “lost motion” between the drive cam 128 and the spindle component 150 is what allows this initial rotation of the inside handle 104 and drive cam 128 (even though the spindle 146 and outside handle are prevented from rotating as explained above). Therefore, when the snib plate 198 is in the snibbing position, a small amount of initial rotation of the handle 104 causes the un-snibbing lug 208 on the drive cam 128 to push the snibbing plate 198 back upwards into its un-snibbing position. After that, further rotation of the inside handle 104 and drive cam 128 causes retraction of the latch bolt in the manner described above (i.e. as shown in FIG. 11).

As explained with reference to FIGS. 7 and 8, the inside handle assembly further incorporates a locking component 116. The locking component 116 includes a pair of locking arms 210 which extend out horizontally, similar to the drive rods 112, 114 and the pillar 192. The two locking arms 210 of the locking component 116 are connected by a connecting portion 212 which is mounted to the housing 102. The connecting portion 212 is best illustrated in FIGS. 13 and 18 (note: in FIG. 13 the housing 102 is not shown so that the other components can be seen from this point of view). The locking component 116 (including the locking arms 210 and the connecting portion 212) is formed as a single unitary component in this embodiment.

The locking component 116 can be moved horizontally relative to the housing 102, between an unlocking and a locking position, by operation of the key cylinder. The way this is done can be understood with reference to FIGS. 10 and 18. In FIG. 10, the locking cam 186 on the inner end of the key cylinder 108 is shown in the orientation it adopts before a key is inserted and turned in the key cylinder. Also, FIG. 10 shows the locking component 116 in its unlocking position. The reason this is the unlocking position of the locking component is because (as can be seen from FIGS. 11 and 12) in this position the locking component 116 does not impede the drive plate 118 from moving downwards to retract the latch bolt. In particular, when it is in this position, the locking component 116 does not impede/block the tab portion 194 of the drive plate 118 from moving down beside the locking component 116 (as illustrated in FIGS. 11 and 12).

If a key is inserted into the key cylinder 108 and rotated in the appropriate direction, this causes the locking cam 186 to rotate in the same direction by the same amount. When the locking cam 186 is thus caused to rotate counterclockwise in the orientation shown in FIG. 10, the locking post 190 initially moves into contact with one of the horizontally extending arms 210 of the locking component 116. Specifically the locking post 190 moves into contact with the arm 210 which is shown on the right hand side in FIG. 10. With further rotation of the locking cam 186, the locking post 190 forces the arm 210 (and hence the whole locking component 116) to move horizontally (to the right in this orientation) from the position shown in FIG. 10 into the position shown in FIG. 18. Note that the position of the locking component 116 shown in FIG. 18 is its locking position. This is because, in this position, the locking component 116 impedes the drive plate 118 from moving downwards. More specifically, in this position, the locking component 116 impedes/blocks the tab portion 194 of the drive plate 118 from moving down beside the locking component 116, and as a result the drive plate 118 is prevented from moving downwards. Accordingly, this prevents the latch bolt from being retracted. If the drive plate 118 cannot move down into the position shown in FIG. 11, it is not possible to retract the latch bolt using either the inside or the outside handle, unless the locking component 116 is first moved back into the unlocking position.

In order to move the locking component back from the locking position (FIG. 18) into the unlocking position (FIGS. 10-12), a key must be inserted into the key cylinder and rotated in the appropriate direction. Such rotation of the key in the key cylinder causes the locking cam 186 to rotate in that same direction (i.e. clockwise in FIGS. 10-12 and 18) by the same amount, and when this happens the locking post 190 initially moves into contact with the arm 210 of the locking component 116 which is shown on the left-hand side in FIGS. 10 and 18. With further rotation of the locking cam 186, the locking post 190 then forces the said arm 210 (and hence the whole locking component 116) to move horizontally (to the left in this orientation) back from the locking position shown in FIG. 18 into the unlocking position shown in FIG. 10.

It should be noted that the length of the arms 210 is such that, when the lock is assembled, the arms 210 extend at least most of the way across the gap between the inside handle assembly 100 and the outside handle assembly 400. The arms 210 (like the post 192 etc) extend through the main cylindrical hole 15 in the door (see FIG. 1a). Because the arms 210 extend at least most of the way across the said gap, it is possible for the locking cam on the inner end of the outside handle assembly's key cylinder to also engage with the arms. The locking cam on the outside handle assembly's key cylinder is illustrated in FIG. 2. In any case, because the locking cam of the outside handle's key cylinder can engage with the arms 210 of the locking component 116, it is possible to move the locking component 116 between its locking and unlocking positions (to lock and unlock the lock) in exactly the same manner as explained in the previous paragraph by operating the outside key cylinder.

As mentioned previously, it is possible to convert the inside handle assembly 100 (and likewise the outside handle assembly 400) from one handedness to the other. The way in which this is done will be described with reference to the inside handle assembly 100 (although these explanations apply equally to the outside handle assembly 400).

Referring to FIG. 9, it will be seen that the inside handle assembly 100 includes a handing stop button 216. It can also be seen that there are a pair of indented regions/recesses 218 in the perimeter edge of the drive cam 128. Also, from FIGS. 9 and 10, it can be seen that when the inside handle assembly is assembled, the handing stop button 216 is mounted in an angled cavity in the housing 102. The zigzag shaped portion on one end of the handing button 216 is resilient and functions as a spring to bias the button 216 out of the said angled cavity in the housing (i.e. it pushes the button 216 out towards the drive cam 128). Furthermore, when the button 216 extends out of the said cavity, the solid portion of the button 216 inserts into one of the recess 218 in the perimeter edge of the drive cam 128. From FIG. 10 it will be appreciated that when the button 216 inserts into the recess 218, this prevents the drive cam 128 (and hence the handle 104) from rotating upward (i.e. counterclockwise in the orientation shown) past the position shown in FIG. 10. This is because any attempt to rotate the handle 104 in this way, when the button 216 is inserted into the recess 218, would cause the sidewall of the recess 218 to collide with the button 216, thus preventing such rotation.

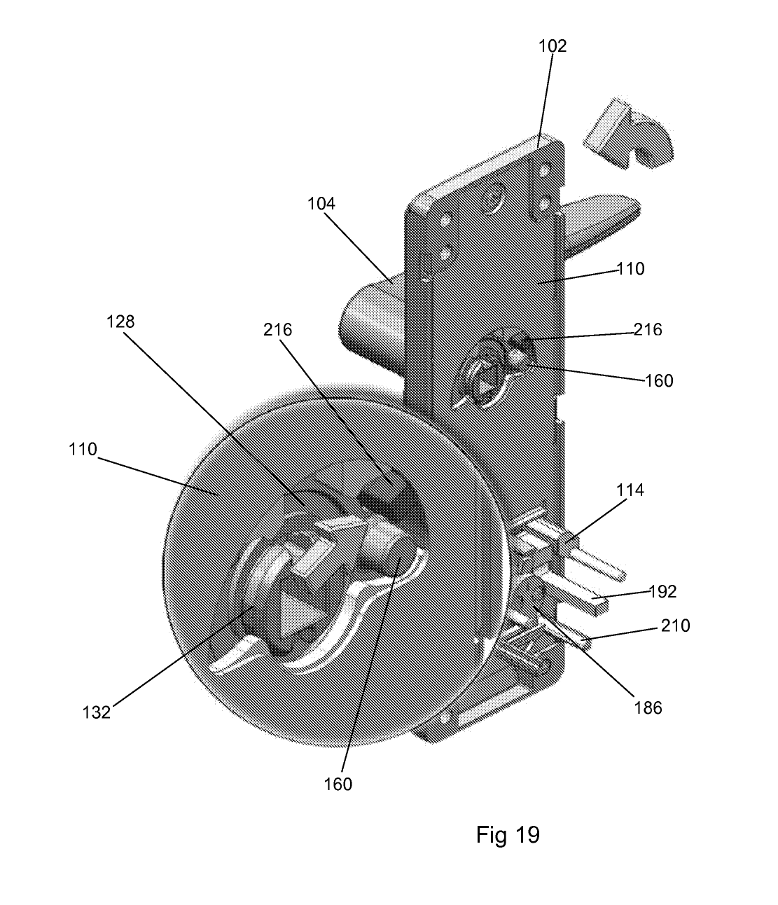

However, in order to convert the assembly 100 from one handedness to the other, it is necessary to rotate the handle in this manner. For instance, in order to convert the assembly from the handedness shown in FIG. 10 (left-handed) to the other handedness (right-handed) it is necessary to rotate the drive cam 128 (and the handle 104) counterclockwise from/past the position shown in FIG. 10. In fact, the handle must be rotated all the way up and over so as to become oriented in the opposite orientation to that shown in FIG. 10 (i.e. so the handle 104 points out to the left, rather than the right, in FIG. 10). To enable this to be done, before the inside handle assembly 100 is installed on the door, and before it is assembled together with the spindle assembly, the handing stop button 216 can be depressed as illustrated in FIG. 19. More specifically, the button 216 can be pressed so that it moves (against the bias of its zigzag-shaped portion) back into the angled cavity in the housing, and so that it is no longer within the recess 218 in the drive cam 128. When the button 216 is thus depressed, and because it is no longer within the recess 218, the button 216 no longer prevents the drive cam 128 (or the handle 104) from rotating upward (counterclockwise in the orientation shown) past the position shown in FIG. 10. Accordingly, when the button 216 is depressed, the handle 104 can be rotated from/past the position shown in FIG. 10, all the way up and over so as to become oriented in the opposite orientation to that shown in FIG. 10. Once the handle reaches the opposite orientation, the handing button 216 “snaps” back out (due to the bias of the zigzag-shaped portion) and inserts into the other of the recesses 218 in the drive cam 128. The engagement of the button 216 in the other recess 218 then retains the handle in the new handedness (i.e. it prevents the handle from being rotated back the other way into the first handedness, unless of course the button is again depressed to allow this).

At this point it is useful to refer again to FIGS. 9 and 9a. Importantly, in these Figures, the various components are shown in their left-handed configuration. FIG. 9a shows the post 140 which projects from the rear of the drive cam 128. It also shows that, in this handedness, the post 140 is positioned behind the outwardly-pointing straight portion 142 of the handle spring 124. The other straight portion 143 of the spring engages a flat surface 144 on the housing 102. The flat surface 144 of the housing is illustrated in FIG. 9. Thus, when the handle 104 is in this handedness, and when it is rotated by a user to operate the lock (e.g. clockwise as shown in FIG. 11) the drive cam 128 rotates with the handle 104 and this causes the post 140 to push against the straight portion 142 of the spring, which in turn causes the spring 124 to deflect in a rotary manner against its natural bias. When the handle is released, the spring 124 (and in particular the straight portion 142) pushes back against the post 140 due to the spring's natural bias, thereby causing the handle to rotate back (counterclockwise in FIGS. 10 and 11) into its original un-rotated position.

Referring again to FIG. 9a, it will be appreciated that when the handle 104 is rotated to convert the handle assembly from the left handedness to the right handedness (this requires the handing button 216 to the depressed etc as explained above), the post 140 on the rear of the drive cam rotates away from the straight portion 142 of the spring 124. However, the spring 124 does not rotate. The spring 124 stays in the same position relative to the housing 102. Therefore, when the handle 104 is rotated through the full 180° required to change handedness, the post 140 on the rear of the drive cam moves out of engagement with the straight portion 142 of the spring and around into engagement with the other straight portion 143 of the spring. At the same time, the straight portion 142 of the spring engages against a flat surface 145 on the housing 102. The flat surface 145 of the housing is illustrated in FIG. 9. Thus, when the handle 104 is in the alternative handedness (not illustrated), and when it is rotated by the user to operate the lock (it would need to be rotated counterclockwise in this case, that is, opposite to the clockwise rotation shown in FIG. 11), the drive cam 128 rotates with the handle 104 and this causes the post 140 to push against the straight portion 143 of the spring, which in turn causes the spring 124 to deflect in a rotary manner against its bias. When the handle is released, the spring 124 (and in particular the straight portion 143) pushes back against the post 140, thereby causing the handle to rotate back into its un-rotated position.

The way in which the various parts and features of the lock operate when the lock is converted into the opposite handedness (i.e. opposite to the handedness shown) will be evident to those skilled in the art from the drawings, even if, or to the extent that, such operation is not expressly explained herein.

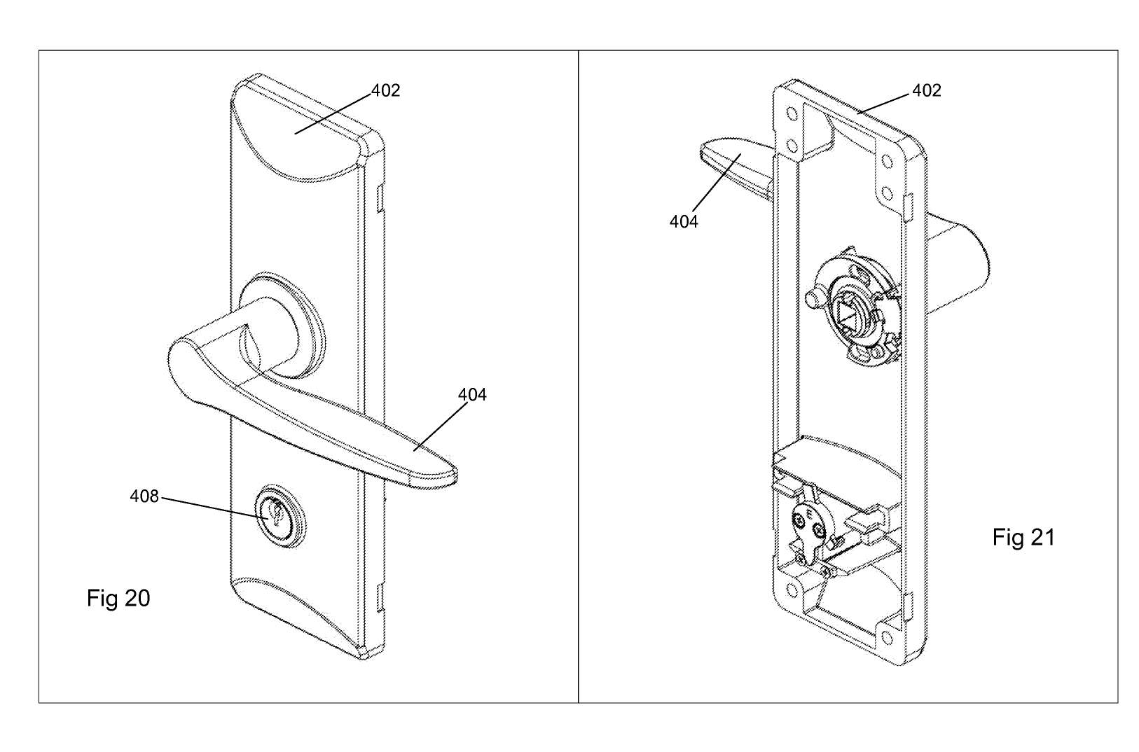

FIGS. 20, 21 and 22 each illustrate the outside handle assembly 400. The components which make up the outside handle assembly 400 are mostly the same as the components used in the inside handle assembly 100 (which are described in detail above). For instance, the lever handle, drive cam, key cylinder, etc, of the outside handle assembly 400 are the same as the lever handle, drive cam, key cylinder, etc, of the inside handle assembly 100. To reflect this similarity, the reference numerals used to identify components/features in FIGS. 20-22 correspond to the reference numerals used to identify corresponding components/features in the earlier Figures, except that for the outside handle assembly the reference numerals begin with the prefix “4” or “5” rather than the prefix “1” or “2” used for the inside handle assembly. For example, whereas the lever handle on the inside handle assembly was indicated by reference numeral 104, the lever handle of the outside handle assembly is indicated by reference numeral 404. Similarly, the drive cam in the outside handle assembly is indicated by reference numeral 428 whereas the drive cam in the inside handle assembly was indicated by reference numeral 128, etc. One component of the outside handle assembly 400 which differs from the corresponding component in the inside handle assembly is the housing 402. The outside handle housing 402 necessarily differs from the inside handle housing 102 because the outside handle housing 402 is not required to receive or interact with numerous of the lock's functional components that form part of the inside handle assembly 100 (e.g. the locking component 116, the drive rods 112 and 114, etc).

It should be noted that the way in which the handedness of the outside handle assembly 400 is switched (by depressing the handing button 516 to allow the handle 404 to be rotated up and over into the opposite handedness) is the same as was explained above for the inside handle assembly 100.

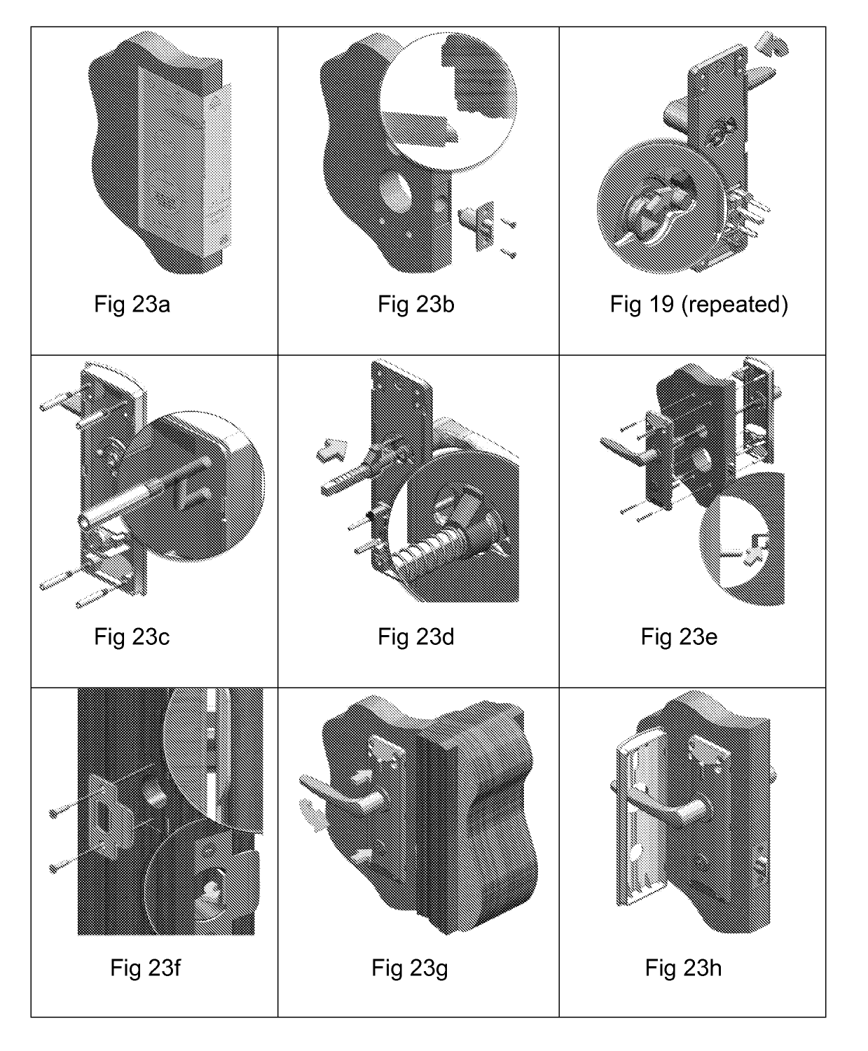

FIGS. 23a-23h summarise the process for installing the lock on the door.

FIG. 23a illustrates the way a stencil can be used to mark out, on the door, the size and placement of the various holes required to mount the lock to the door. After the holes have been marked out, the holes may be formed (cut or drilled), thus resulting in a door as shown in FIG. 1a which is ready to receive the lock.

FIG. 23b illustrates the way that the latch bolt assembly is next fitted to the side edge of the door. Note that the latch bolt assembly 300 should be oriented with the curved edge of the latch bolt head facing towards the doorjamb, as illustrated in the magnified detail in FIG. 23b. Importantly, there is no need whatsoever to disassemble the latch bolt assembly to correctly orient the latch bolt. The latch bolt assembly can simply be installed in the orientation shown, or flipped over and installed with the curved edge of the latch bolt head facing the other way, as required.

Next, FIG. 19 (which is repeated from above) illustrates the way that the handing stop button 216 can be depressed to enable the handedness to be switched. Note that this step may not be necessary if the handles are already in the correct handedness. Also note that both the inside handle assembly 100 and the outside handle assembly 400 must be configured in the correct handedness (only the inside handle assembly 100 is illustrated in FIG. 19). As has been mentioned, the way in which the handedness is switched is described above, and is the same for the inside handle assembly and the outside handle assembly. The way in which the handedness of the handle assemblies in this lock design can be switched is far easier and safer than is the case of the prior art locks discussed in the Background section above.

FIG. 23c illustrates the way that the spacer bolts (also illustrated in FIG. 3) are next screwed into the housing 402 of the outside handle assembly 400. Note that at the top of the housing 402 there are two sets of holes which can receive the spacer bolts (the same is true for the inside housing 102). These two sets of holes are provided to allow for different lock “footprints” (i.e. different spacings of the holes in the door through which the spacer bolts extend when the lock is mounted to the door). Therefore, as illustrated in the magnified detail in FIG. 23c, the spacer bolts should only be inserted into the holes in the housing which correspond to “footprint”/spacing of the holes in the door.

In the next step, illustrated in FIG. 23d, the spindle assembly is assembled together with the inside handle assembly 100. Note that, whichever handedness the inside handle assembly is in (FIG. 23d illustrates it in the left-handed configuration), the spindle assembly must nevertheless always be inserted with the spindle component 150 oriented upward. The reason for this is explained above.

Next, as illustrated in FIG. 23e, the inside handle assembly 100 and the outside handle assembly 400 should be screwed together using fasteners which extend through the holes in the door. Importantly, as the assemblies are thus screwed together (and as illustrated in the magnified detailing FIG. 23e) care should be taken to ensure that the rod portion of the appropriate drive rod (i.e. the rod portion 170 of the first drive rod 112, or the rod portion 178 of the second drive rod 114, as appropriate depending on the handedness) inserts through the closed loop 318 extending from the rear of the latch bolt assembly.

The next step, as illustrated in FIG. 23f, is to mount the strike plate 10 to the door jamb. If not already done, a hole should be drilled into the door frame (the hole should correspond to, and align with, the main central opening in the strike plate 10) to receive the latch bolt when the door is closed. Also, as shown in the upper magnified detail in FIG. 23f, when positioning the strike, care should be taken that the auxiliary latch bolt 306 remains out of the strike (i.e. the auxiliary latch bolt 306 should not go into the hole in the strike) when the door is fully closed. Furthermore, if necessary, the tab portion attached on one side edge of the hole in the strike can be bent out (as illustrated in the lower magnified detailing FIG. 23f) to reduce door rattle.

Next, FIG. 23g illustrates that the functionalities of the lock should be tested by testing the operation of the handles, the key cylinders and the snib button. And finally, as illustrated in FIG. 23h, the external furniture covers should be fitted over the respective housings on either side of the door.

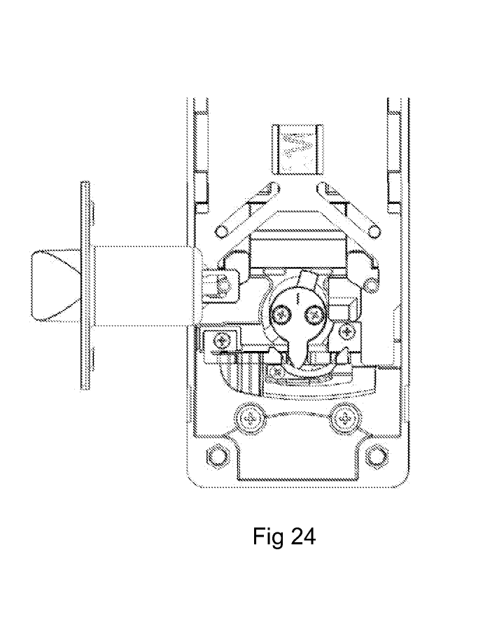

FIG. 24 relates to a possible alternative lock embodying the present invention. FIG. 24 is, in effect, the same as FIG. 18 except that the lock handle and its associated components which are shown in FIG. 18 are not shown in FIG. 24. This is because FIG. 24 is intended to represent an embodiment in which there are no lock handles on either side of the door. Instead, in the embodiment represented in FIG. 24, there is only a lock cylinder on either side of the door. Therefore, in order to operate the lock from either side of the door, it is necessary to operate the relevant lock cylinder. This may require the use of a key from either side. Or, for example, if the lock cylinder on the inside of the door were a type which has a turn knob (or the like) for operating the cylinder (rather than a key), the lock may be operated from the inside by turning the knob. In any case, a lock in accordance with this alternative embodiment would operate in the same way as the embodiment described above insofar as the operation of the lock by the cylinder(s) is concerned. In other words, in the lock in this alternative embodiment, the latch bolt can be retracted by operation of either key cylinder, and the lock can be locked by operation of either key cylinder, in the same way as in the embodiment above. Of course, the lock in this alternative embodiment has no snib mechanism (there is no need for a snib mechanism if the lock has no handles as there is no need to “snib” the lock to prevent operation of the outside handle). Also, the issue of handedness is not relevant to the lock in this alternative embodiment (again, because the lock has no handles). Nevertheless, the lock in this alternative embodiment still provides the benefit that the latch bolt assembly could be installed to engage the first drive rod 112, or alternatively the second drive rod 114, as required, depending on whether the lock is to be installed on a door which is hinged on one side or the other.

Another possible embodiment of the invention (not illustrated in the drawings) relates to the latch rather than a lock. Consider, for instance, if the inside assembly illustrated in FIGS. 10-12 were modified to omit the locking component 116 and also the snib button 106 and snib plate 198 etc. The resulting inside assembly, if used with the outside assembly and latch bolt assembly etc as illustrated, would not have any capability of preventing retraction of the latch bolt by operation of the handles. A latch would therefore be provided, not a lock.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A lock or latch having
a latch bolt which can move linearly between a latching position and an unlatching position;
rotatable operating means that can be operated by a user;
a drive member which can move linearly between a first position and a second position in a direction at least partially transverse to the latch bolt's direction of movement, wherein movement of the drive member from the first position to the second position can be caused by rotation of the operating means, the drive member also having a contact surface oriented at an angle to its direction of linear movement, and
a contact part which is associated with the latch bolt and which can move linearly between a non-retracting position and a retracting position in a direction at least partially parallel to the latch bolt's direction of movement,
wherein the angled contact surface of the drive member engages the contact part, or a portion of the contact part, such that when the drive member moves from the first position to the second position, the contact part, or the said portion of the contact part, moves along the contact surface due to the angle of engagement with the contact surface, thereby moving the contact part from the non-retracting position to the retracting position, and
wherein movement of the contact part from the non-retracting position to the retracting position causes the latch bolt to move from the latching position to the unlatching position.

2. The lock or a latch, as claimed in claim 1, wherein
the drive member has a slot, indent or cutout therein, and a side or edge of the slot, indent or cutout which is oriented at an angle to the direction of linear movement of the drive member forms the contact surface,
the lock or latch further comprises a transfer component and the transfer component has a lug or detent thereon which forms the contact part, and
the transfer component has a further portion which, in use, directly or indirectly engages the latch bolt such that movement of the transfer component with the contact part between the non-retracting position and the retracting position causes the latch bolt to move from the latching position to the unlatching position.

3. The lock or a latch, as claimed in claim 2, wherein
the drive member also has a second slot, indent or cutout therein, and a side or edge of the second slot, indent or cutout which is oriented at an angle to the direction of linear movement of the drive member forms a second contact surface,
the lock or latch further comprises a second transfer component which can move linearly between a non-retracting position and a retracting position in a direction parallel but opposite to the direction of movement of the first-mentioned contact part and transfer component, the second transfer component also having a lug or detent thereon which forms a second contact part that engages the second contact surface,
the second transfer component has a portion which can, in use, directly or indirectly engage the latch bolt,
wherein, in use, only the first-mentioned transfer component interacts with the latch bolt when the lock is in one handedness, and only the second transfer component interacts with the latch bolt when the lock is in the other handedness.

4. The lock or a latch, as claimed in claim 1, configured for mounting to a door and having a lever handle for each of the inside and the outside of the door.

5. The lock or a latch, as claimed in claim 4, wherein the inside handle is part of, or attaches to, an inside handle assembly which is securable on the inside of the door, and the outside handle is part of, or attaches to, an outside handle assembly which is securable on the outside of the door.

6. The lock or a latch, as claimed in claim 5, wherein one or both of the inside handle assembly and the outside handle assembly includes a component which can be pressed or otherwise moved without disassembling the assembly in any way, and when the said component is thus pressed or moved, the handle is able to be rotated relative to the assembly so as to swap the handedness of the assembly.

7. The lock or a latch, as claimed in claim 5, further having a spindle assembly which includes a spindle, wherein, in use, the spindle assembly extends between the inside handle assembly and the outside handle assembly, rotation of the outside handle causes rotation of the spindle, and the spindle is linked to the inside handle by one or more intermediate components.

8. The lock or a latch, as claimed in claim 7, wherein the intermediate components include a drive part and a spindle component, wherein, in use,
rotation of the inside handle causes rotation of the drive part,
the spindle component rotates with the spindle,
rotation of the spindle can cause the spindle component to engage with the drive part and thereby cause rotation of the drive part, and
rotation of the drive part causes the drive member to move from the first position to the second position.

9. The lock or latch, as claimed in claim 8, wherein the drive part is, in use, fixed to rotate with the inside handle and has a drive lug thereon, wherein when the drive part rotates in an opening direction, the drive lug engage with an edge, ridge or surface on the drive member and thereby causes the drive member to move linearly from the first position to the second position.

10. A lock comprising the lock or latch as claimed in claim 7, and further comprising a snib mechanism which, when operated in use, prevents the lock's outside handle from being operated to retract the latch bolt.

11. The lock as claimed in claim 10, wherein the snib mechanism includes a button or turn knob mounted as part of the inside handle assembly and which is operable from the inside of the door, and wherein when the button or turn knob is operated, a snibbing component in the inside handle assembly moves from an un-snibbing position in which it does not prevent rotation of the spindle into a snibbing position in which it prevents rotation of the spindle.

12. The lock as claimed in claim 11, wherein the snibbing component can be moved from the snibbing position to the un-snibbing position by rotation of the inside handle.

13. A lock comprising
a latch bolt which can move linearly between a latching position and an unlatching position;
rotatable operating means that can be operated by a user;
a key cylinder on one or both sides of the lock;
a drive member which can move linearly between a first position and a second position in a direction at least partially transverse to the latch bolt's direction of movement, wherein movement of the drive member from the first position to the second position can be caused by rotation of the operating means, the drive member also having a contact surface oriented at an angle to its direction of linear movement, and
a contact part which is associated with the latch bolt and which can move linearly between a non-retracting position and a retracting position in a direction at least partially parallel to the latch bolt's direction of movement,
wherein the angled contact surface of the drive member engages the contact part, or a portion of the contact part, such that when the drive member moves from the first position to the second position, the contact part, or the said portion of the contact part, moves along the contact surface due to the angle of engagement with the contact surface, thereby moving the contact part from the non-retracting position to the retracting position, and
wherein movement of the contact part from the non-retracting position to the retracting position causes the latch bolt to move from the latching position to the unlatching position.

14. The lock as claimed in claim 13 further comprising
a locking component which can be moved, by operation of a key cylinder, from an un-locking position to a locking position,
wherein in the unlocking position the locking component does not prevent the drive member from moving from the first position to the second position, but in the locking position the locking component prevents the drive member from moving from the first position to the second position.

15. The lock as claimed in claim 13, wherein the drive member can be moved from the first position to the second position by operation of the key cylinder.

16. A latch bolt assembly for use with a lock or latch, the latch bolt assembly including a bolt, a bolt casing and an engaging portion, wherein
the bolt can move relative to the casing between an extended position in which a portion of the bolt projects out from the front of the casing and a retracted position in which the said portion of the bolt is withdrawn at least partially relative to the casing, and
the engaging portion is directly or indirectly connected to the bolt, it extends out from the rear of the casing, and is operable or configured to engage with a part of the lock or latch which can move in a similar manner to the bolt from an un-operated position to an operated position
such that, when the latch bolt assembly is connected to the lock or latch in use, operation of the lock or latch causes the said part of the lock or latch to move from the un-operated position to the operated position and this in turn causes the bolt to move from the extended position to the retracted position.
